(19) United States
(12) Patent Application Publication
(10) Pub. No.: US 2024/0340862 A1
(43) Pub. Date: Oct. 10, 2024

(54) TERMINAL, BASE STATION, AND COMMUNICATION METHOD

(71) Applicant: Panasonic Intellectual Property Corporation of America, Torrance, CA (US)

(72) Inventors: Shotaro MAKI, Kanagawa (JP); Ayako HORIUCHI, Kanagawa (JP); Akihiko NISHIO, Osaka (JP); Tetsuya YAMAMOTO, Kanagawa (JP); Hidetoshi SUZUKI, Kanagawa (JP)

(21) Appl. No.: 18/695,252

(22) PCT Filed: May 18, 2022
(86) PCT No.: PCT/JP2022/020730

§ 371 Date: Mar. 25, 2024

(30) Foreign Application Priority Data
Sep. 29, 2021 (JP) 2021-159523

(51) Int. Cl. H04W 72/044; H04W 48/08; H04W 72/512

(52) U.S. Cl. CPC H04W 72/044; H04W 48/08; H04W 72/512

(57) ABSTRACT

This terminal is provided with: a control circuit for setting some or all synchronization signal block numbers associated with a first transmission opportunity for a terminal of a first type in one time resource to a synchronization signal block number associated with a second transmission opportunity for a terminal of a second type in one time resource; and a transmitting circuit for transmitting a signal in a transmission opportunity.

### TECHNICAL FIELD

The present disclosure relates to a terminal, a base station, and a communication method.

### BACKGROUND ART

A communication system called the 5th generation mobile communication system (5G) has been studied. The 3rd Generation Partnership Project (3GPP), which is an international standards-developing organization, has been studying development of the 5G communication system in terms of both the development of LTE/LTE-Advanced systems and a New Radio Access Technology (also referred to as New RAT or NR), which is a new method not necessarily backward compatible with the LTE/LTE-Advanced systems (see, e.g., Non Patent Literature (hereinafter referred to as “NPL”) 1).

### CITATION LIST

### Non Patent Literature

### NPL 1

RP-181726, “Revised WID on New Radio Access Technology”, NTT DOCOMO, September 2018

### NPL 2

RP-193238, “New SID on Support of Reduced Capability NR Devices”, Ericsson, December 2019

### NPL 3

3GPP TS 38.213 V16.6.0, “NR; Physical layer procedures for control (Release 16)”, 2021-06

### SUMMARY OF INVENTION

However, there is room for further study on a method for suppressing an increase in the complexity of a base station to which a terminal is connected.

A non-limiting embodiment of the present disclosure facilitates providing a terminal, a base station, and a communication method each capable of suppressing an increase in the complexity of a base station to which a terminal is connected.

A terminal according to an embodiment of the present disclosure includes: control circuitry, which, in operation, configures some or all of synchronization signal block numbers associated with a first transmission occasion for a first-type terminal in one time-resource, for synchronization signal block numbers associated with a second transmission occasion for a second-type terminal in one time-resource; and transmission circuitry, which, in operation, transmits a signal in the second transmission occasion.

It should be noted that general or specific embodiments may be implemented as a system, an apparatus, a method, an integrated circuit, a computer program, a storage medium, or any selective combination thereof.

According to an embodiment of the present disclosure, it is possible to suppress an increase in the complexity of a base station to which a terminal is connected.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary configuration of a Random access Occasion (RO);

FIG. 2 illustrates exemplary transmission and reception of a random access preamble;

FIG. 3 is a block diagram illustrating an exemplary configuration of a part of a base station;

FIG. 4 is a block diagram illustrating an exemplary configuration of a part of a terminal;

FIG. 5 is a block diagram illustrating an exemplary configuration of the base station;

FIG. 6 is a block diagram illustrating an exemplary configuration of the terminal;

FIG. 7 is a sequence diagram illustrating exemplary operations of the base station and the terminal according to Operation example 1;

FIG. 8 illustrates exemplary RO configurations according to Operation example 1;

FIG. 9 illustrates other exemplary RO configurations according to Operation example 1;

FIG. 10 illustrates still other exemplary RO configurations according to Operation example 1;

FIG. 11 is a sequence diagram illustrating exemplary operations of the base station and the terminal according to Operation example 2;

FIG. 12 illustrates exemplary RO configurations according to Operation example 2;

FIG. 13 illustrates other exemplary RO configurations according to Operation example 2;

FIG. 14 illustrates exemplary parameters on RO configurations;

FIG. 15 illustrates exemplary RO configurations;

FIG. 16 illustrate an exemplary shared RO;

FIG. 17 illustrates an exemplary architecture of a 3GPP NR system;

FIG. 18 schematically illustrates a functional split between NG-RAN and 5GC;

FIG. 19 is a sequence diagram of a Radio Resource Control (RRC) connection setup/reconfiguration procedure;

FIG. 20 is a schematic diagram illustrating a usage scenario of an enhanced Mobile BroadBand (eMBB), massive Machine Type Communications (mMTC), and Ultra Reliable and Low Latency Communications (URLLC); and

FIG. 21 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

Note that, in the following description, a radio frame, a slot, and a symbol are each a physical resource unit in time domain, for example. For example, the length of one frame may be 10 milliseconds. For example, one frame may be configured by a plurality (e.g., 10, 20, or another value) of slots. Further, for example, the number of slots configuring one frame may be variable depending on the slot length. Furthermore, for example, one slot may be configured by a plurality (e.g., 14 or 12) of symbols. For example, one symbol is the smallest physical resource unit in time domain, and the symbol length may vary depending on the subcarrier spacing (SCS).

Further, a subcarrier and a resource block (RB) are each a physical resource unit in frequency domain. For example, one resource block may be configured by 12 subcarriers. For example, one subcarrier may be the smallest physical resource unit in frequency domain. The subcarrier spacing is variable, and may be 15 kHz, 30 kHz, 60 kHz, 120 kHz, 240 kHz, or another value, for example.

### [Random Access Occasion (RO)]

For example, a terminal (e.g., also referred to as a mobile station or a User Equipment (UE)) conforming to Release 15 or Release 16 (hereinafter, also referred to as “Rel-15/16 NR”) may receive system information (e.g., SIB: System Information Block) and acquire an uplink allocation band (e.g., initial Uplink Bandwidth Part (BWP)) and configuration information on a Random access Occasion (RO) in the initial Uplink BWP. For example, the terminal transmits a random access preamble in the RO in the initial UL BWP in accordance with the acquired configuration information.

Note that the RO may also be referred to as a Physical Random Access Channel (PRACH) occasion, a Random Access Channel (RACH) occasion, or a transmission occasion, for example. The random access preamble may also be referred to as a random access preamble, Message 1 (Msg1), Message A (MsgA), a RACH preamble, or simply a “preamble,” for example.

The RO configuration may include, for example, the following configurations:
The number of times where ROs are Frequency Division Multiplexed (FDMed) (hereinafter, referred to as the number of FDMed ROs) (e.g., may take a value of one, two, four, or eight); and
The number of Synchronization Signal (SS)/Physical Broadcast Channel (PBCH) block indexes (SSB indexes) corresponding to an RO (e.g., may take a value of ⅛, ¼, ½, 1, 2, 4, 8, or 16).

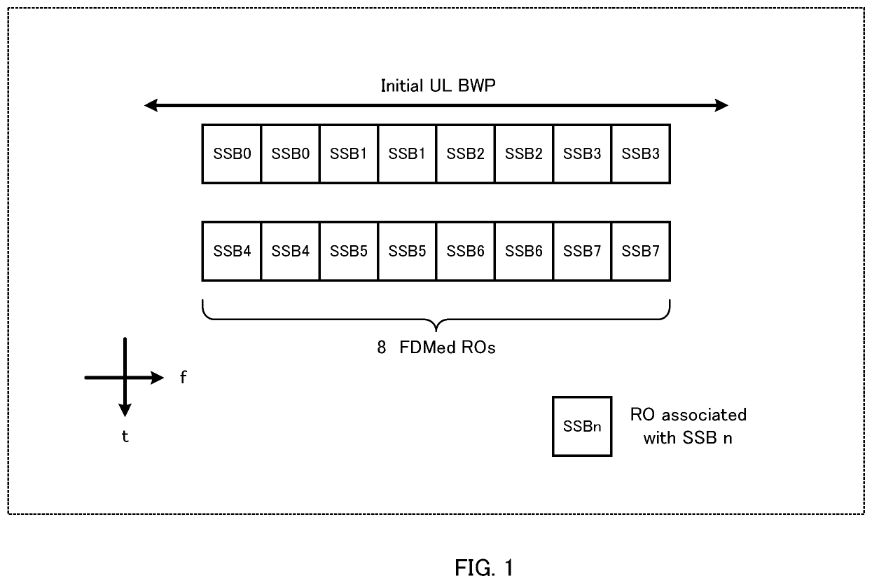

FIG. 1 illustrates an exemplary RO configuration. FIG. 1 illustrates an exemplary RO configuration in which the number of FDMed ROs is set to 8 and the number of SSB indexes corresponding to an RO is set to ½.

As illustrated in FIG. 1, eight ROs are frequency-multiplexed in each time-resource where ROs are configured. Further, as illustrated in FIG. 1, one SSB index is configured corresponding to two ROs. Note that, as illustrated in FIG. 1, in ROs configured for terminals, SSB indexes may be configured in ascending order and in the order of frequency domain and time domain, for example. Note that the RO configuration method in frequency domain and time domain is not limited thereto.

The reason why SSB indexes are configured to ROs is, for example, that a terminal receives SSBs associated with a plurality of beams in advance and indicates the SSB in a better reception state among the received SSBs to a base station (e.g., also referred to as a gNB) through preamble transmission. For example, the terminal may transmit a preamble using an RO corresponding to the SSB index of the SSB in a better reception state among the received SSBs. Thus, the reception beam of the base station may be different depending on the SSB corresponding to each RO.

### [Reduced Capability NR Devices]

In Release 17 (hereinafter, referred to as Rel-17 NR), a specification (e.g., Reduced Capability (RedCap)) is expected to be developed for realizing a terminal (e.g., NR terminal) whose power consumption or cost is reduced by limiting some of the functions or performance to support various use cases, compared to Rel-15/16 NR (e.g., initial release of NR) (e.g., see NPL 2).

Such a terminal is sometimes referred to as a reduced capability NR Device, RedCap, a RedCap terminal, NR-Lite, or NR-Light, for example.

In order to reduce power consumption or cost, reduction in the computational complexity of the terminal has been studied, for example. One method for reducing the computational complexity of the terminal is, for example, a method for configuring a bandwidth supported by the terminal to be narrower than the bandwidth supported by the existing terminal. For example, the maximum frequency bandwidth supported by a terminal different from the RedCap terminal (hereinafter, referred to as “non-RedCap” or a “non-RedCap terminal” for convenience) may be 100 MHz in FR1 (frequency range 1) and 200 MHz in FR2 (frequency range 2). On the other hand, the maximum frequency bandwidth supported by the RedCap terminal may be 20 MHz in FR1 and 100 MHz in FR2.

Thus, for example, an initial UL BWP configured for a non-RedCap terminal is possibly wider than the bandwidth supported by a RedCap terminal. For example, an initial UL BWP different from the initial UL BWP for a non-RedCap terminal (hereinafter, referred to as a “separate initial UL BWP”) may be configured for a RedCap terminal. Thus, an RO in the separate initial UL BWP may be different from an RO configured for a non-RedCap terminal.

For example, there is room for further study on a method for configuring an SSB index for an RO configured for a RedCap terminal. For example, there is room for further study on a method for configuring an SSB index corresponding to an RO for a RedCap terminal without increasing the complexity of a base station to which the RedCap terminal is connected.

Then, anon-limiting embodiment of the present disclosure describes an SSB index configuration method that, for example, suppresses an increase in the complexity of a base station to which a RedCap terminal is connected.

For example, in anon-limiting embodiment of the present disclosure, a combination of SSB indexes that may be configured in a certain time resource in an RO configuration for a RedCap terminal may be a part (subset) or all of a combination of SSB indexes that may be configured in the certain time resource in an RO configuration for a non-RedCap terminal.

For example, in FIG. 1, SSB indexes associated with ROs in a certain time resource in the RO configuration for a non-RedCap terminal are a combination of SSB0 to SSB3 or a combination of SSB4 to SSB7. In this case, SSB indexes associated with ROs in one time-resource in the RO configuration for a RedCap terminal may be configured to at least some of SSB0 to SSB3 or some of SSB4 to SSB7. In other words, for SSB indexes associated with ROs in one time-resource for the RO configuration for a RedCap terminal, some of SSB0 to SSB3 and some of SSB4 to SSB7 are not combined to be configured.

Note that the time resource in which an RO for a non-RedCap terminal is configured and the time resource in which an RO for a RedCap terminal is configured may be different from each other or may be at least partly the same.

This SSB index configuration for an RO can reduce an increase in the complexity of the base station. This is based on the following reason.

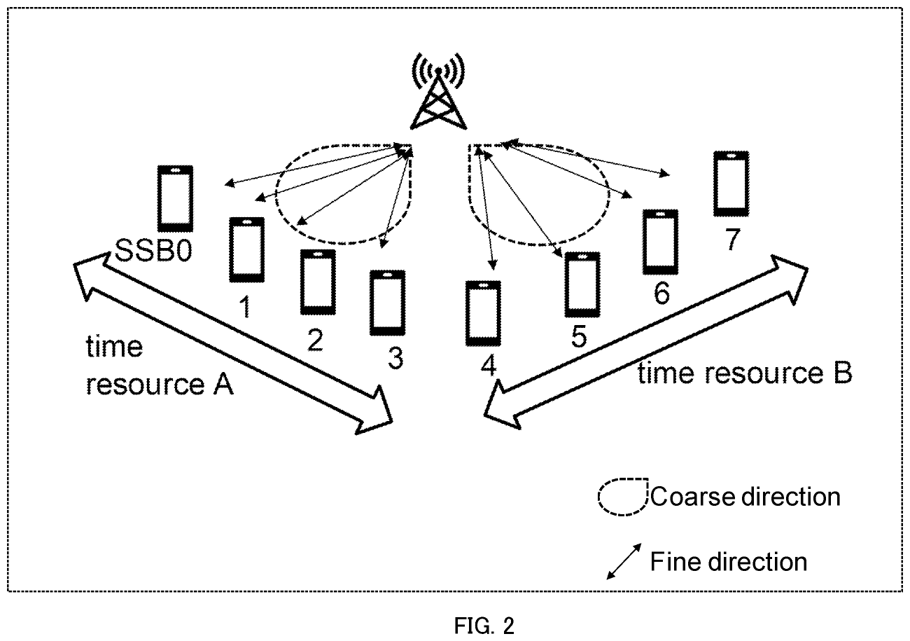

FIG. 2 illustrates an example in which a base station receives a random access preamble transmitted by a terminal. As illustrated in FIG. 2, a terminal receives SSB(s) (e.g., at least one of SSB0 to SSB7) from a base station and transmits a random access preamble using an RO associated with any of the received SSB(s). Further, when the base station receives the random access preamble on the RO, the base station may specify a coarse direction of a reception beam by analog beamforming and specify a further fine direction by digital beamforming.

In the example illustrated in FIG. 2, the coarse direction of the beam in time resource A is oriented in directions corresponding to SSB0, SSB1, SSB2 and SSB3. Thus, the base station can receive a random access preamble from any of the terminals located in the directions corresponding to SSB0, SSB1, SSB2, and SSB3 in time resource A. Meanwhile, in time resource A, directions corresponding to SSB4, SSB5, SSB6, and SSB7 are out of the range of directions of reception beams of the base station. Thus, the base station does not receive random access preambles from terminals located in the directions corresponding to SSB4, SSB5, SSB6 and SSB7.

Further, in the example illustrated in FIG. 2, the coarse direction of the beam in time resource B is oriented in directions corresponding to SSB4, SSB5, SSB6 and SSB7. Thus, the base station can receive a random access preamble from any of the terminals located in the directions corresponding to SSB4, SSB5, SSB6, and SSB7 in time resource B. Meanwhile, in time resource B, the directions corresponding to SSB0, SSB1, SSB2, and SSB3 are out of the range of directions of reception beams of the base station. Thus, the base station does not receive random access preambles from terminals located in the directions corresponding to SSB0, SSB1, SSB2 and SSB3.

As described above, there is a limit on a range receivable by the base station in a certain time-resource.

The combination of SSB indexes that may be configured in one time-resource for ROs for non-RedCap terminals can be herein regarded as a beam range (in other words, SSB index) that can be received by the base station in the one time-resource. For example, in FIG. 2, in the RO configuration for a non-RedCap terminal, the combination of SSB indexes that can be configured in one time-resource may be either a combination of SSB0 to SSB3 or a combination of SSB4 to SSB7.

Thus, SSB indexes associated with ROs for a RedCap terminal in one time-resource may be configured within a beam range receivable by the base station (e.g., SSB indexes configured for a non-RedCap terminal) in the one time-resource. Accordingly, for example, the base station does not need to perform reception processing in a range exceeding the receivable beam range in one time-resource in order to receive a random access preamble from a RedCap terminal, which can suppress an increase in the complexity of the base station.

Further, for example, when an RO for a RedCap terminal and an RO for a non-RedCap terminal are configured in the same time resource, the SSB index type (e.g., beam range receivable by the base station) configured for the RO for the RedCap terminal and the index type configured for the RO for the non-RedCap terminal may be the same. This allows the base station to, for example, receive a random access preamble from each of a RedCap and a non-RedCap terminal in the same beam range in one time-resource, thus further reducing the complexity of the base station.

An exemplary method for configuring the above-mentioned SSB index will be hereinafter described.

### [Overview of Communication System]

A communication system according to the present embodiment includes base station 100 and terminal 200.

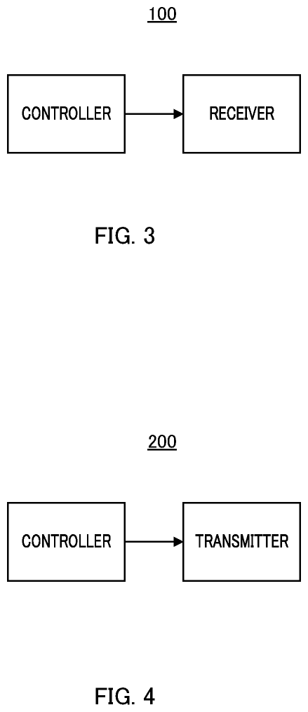

FIG. 3 is a block diagram illustrating an exemplary configuration of a part of base station 100 according to the present embodiment. In base station 100 illustrated in FIG. 3, a controller (e.g., corresponding to control circuitry) configures some or all of SSB indexes associated with ROs (e.g., first transmission occasion) for a non-RedCap terminal (e.g., first-type terminal) in one time-resource to be SSB indexes associated with ROs (e.g., second transmission occasion) for a RedCap terminal (e.g., second-type terminal) in one time-resource. A receiver (e.g., corresponding to reception circuitry) receives a random access preamble in the RO for a RedCap terminal.

FIG. 4 is a block diagram illustrating an exemplary configuration of a part of terminal 200 according to the present embodiment. In terminal 200 illustrated in FIG. 4, a controller (e.g., corresponding to control circuitry) configures some or all of SSB indexes associated with ROs (e.g., first transmission occasion) for a non-RedCap terminal (e.g., first-type terminal) in one time-resource to be SSB indexes associated with ROs (e.g., second transmission occasion) for a RedCap terminal (e.g., second-type terminal) in one time-resource. A transmitter (e.g., corresponding to transmission circuitry) transmits a random access preamble in the RO for a RedCap terminal.

### [Configuration of Base Station]

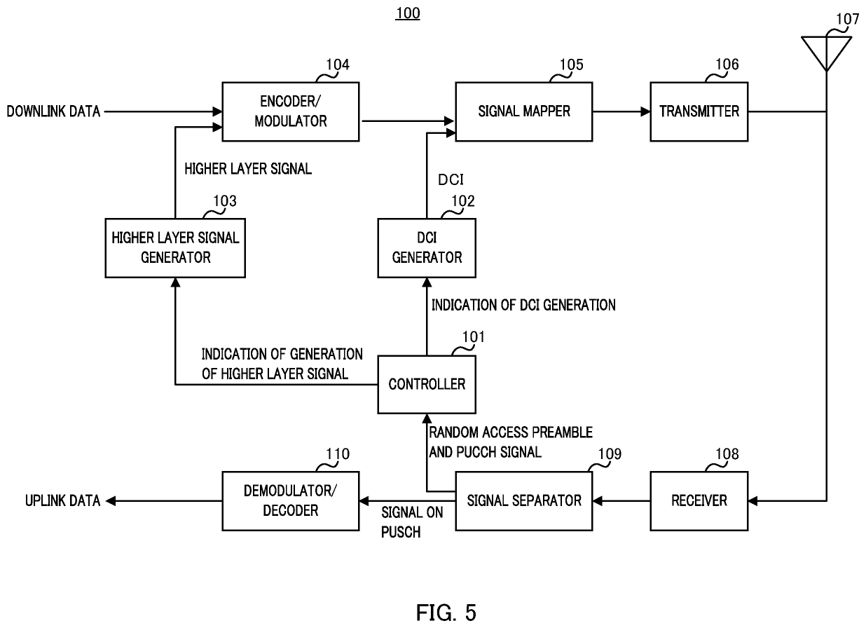

FIG. 5 is a block diagram illustrating an exemplary configuration of base station 100 according to the present embodiment. In FIG. 5, base station 100 includes controller 101, DCI generator 102, higher layer signal generator 103, encoder/modulator 104, signal mapper 105, transmitter 106, antenna 107, receiver 108, signal separator 109, and demodulator/decoder 110.

At least one of controller 101, DCI generator 102, higher layer signal generator 103, encoder/modulator 104, signal mapper 105, signal separator 109, and/or demodulator/decoder 110 illustrated in FIG. 5 may be included in the controller illustrated in FIG. 3. At least one of antenna 107 and/or receiver 108 illustrated in FIG. 5 may be included in the receiver illustrated in FIG. 3.

For example, controller 101 may determine at least one configuration of an initial UL BWP and/or RO. Based on the determined configuration, controller 101 may indicate, to higher layer signal generator 103, generation of a higher layer signal (e.g., also referred to as a higher layer parameter or higher layer signaling) such as system information. Further, controller 101 may determine a configuration of a downlink control channel (e.g., Physical Downlink Control Channel (PDCCH)) or control information (e.g., Downlink Control Information (DCI)) included in the downlink control channel, for example. Based on the determined information, controller 101 may indicate, to DCI generator 102, generation of downlink control information (e.g., DCI).

Further, controller 101 may control transmission processing (e.g., processing of transmitting a downlink signal) based on a random access preamble or a signal of an uplink control channel (e.g., Physical Uplink Control Channel (PUCCH)) inputted from signal separator 109.

For example, DCI generator 102 may generate DCI based on the indication from controller 101 and output the generated DCI to signal mapper 105.

Higher layer signal generator 103 may generate a higher layer signal such as system information based on the indication from controller 101 and output the generated higher layer signal to encoder/modulator 104, for example.

Encoder/modulator 104 may, for example, perform error correction encoding and modulation on downlink data (e.g., Physical Downlink Shared Channel (PDSCH)) and the higher layer signal inputted from higher layer signal generator 103, and output the modulated signal to signal mapper 105.

For example, signal mapper 105 may map the DCI inputted from DCI generator 102 and the signal inputted from encoder/modulator 104 to resources. For example, signal mapper 105 may map the signal inputted from encoder/modulator 104 to a PDSCH resource and map the DCI to a PDCCH resource. Signal mapper 105 outputs the signal mapped to each resource to transmitter 106.

For example, transmitter 106 performs radio transmission processing including frequency conversion (e.g., up-conversion) using a carrier wave on the signal inputted from signal mapper 105, and outputs the signal after the radio transmission processing to antenna 107.

Antenna 107 radiates the signal (e.g., downlink signal) inputted from transmitter 106 toward terminal 200, for example. Further, antenna 107 receives an uplink signal transmitted from terminal 200 and outputs the uplink signal to receiver 108, for example.

The uplink signal may be, for example, an uplink data channel (e.g., Physical Uplink Shared Channel (PUSCH)), an uplink control channel (e.g., PUCCH), or a signal delivered by RO (e.g., random access preamble).

For example, receiver 108 performs radio reception processing including frequency conversion (e.g., down-conversion) on the signal inputted from antenna 107, and outputs the signal after the radio reception processing to signal separator 109.

Signal separator 109 extracts (in other words, separates) a signal on an RO (e.g., random access preamble) or a signal on a PUCCH resource (e.g., PUCCH signal) from signals inputted from receiver 108, and outputs the signals to controller 101, for example. Further, signal separator 109 outputs, from signals inputted from receiver 108, a signal on a PUSCH resource to demodulator/decoder 110.

For example, demodulator/decoder 110 demodulates and decode the signal inputted from signal separator 109, and outputs uplink data.

### [Configuration of Terminal]

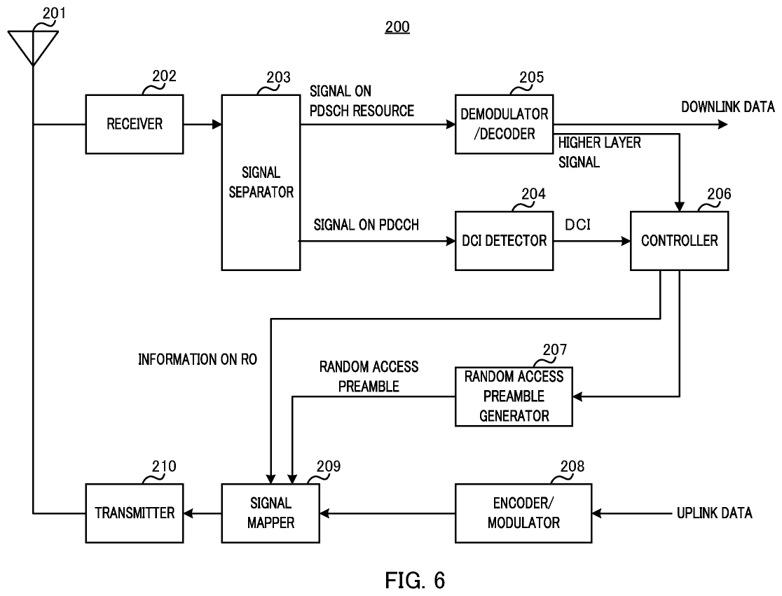

FIG. 6 is a block diagram illustrating an exemplary configuration of terminal 200 according to the present embodiment.

In FIG. 6, terminal 200 includes antenna 201, receiver 202, signal separator 203, DCI detector 204, demodulator/decoder 205, controller 206, random access preamble generator 207, encoder/modulator 208, signal mapper 209, and transmitter 210.

At least one of signal separator 203, DCI detector 204, demodulator/decoder 205, controller 206, random access preamble generator 207, encoder/modulator 208, and/or signal mapper 209 illustrated in FIG. 6 may be included in the controller illustrated in FIG. 4. Further, at least one of antenna 201 and transmitter 210 illustrated in FIG. 6 may be included in the transmitter illustrated in FIG. 4.

Antenna 201 receives a downlink signal transmitted by base station 100 and outputs the downlink signal to receiver 202. Further, antenna 201 radiates an uplink signal inputted from transmitter 210 to base station 100.

For example, receiver 202 performs radio reception processing including frequency conversion (e.g., down-conversion) on the signal inputted from antenna 201, and outputs the signal after the radio reception processing to signal separator 203.

Signal separator 203 extracts (in other words, separates) a signal on a PDCCH resource from signals inputted from receiver 202 and outputs the signal to DCI detector 204, for example. Further, signal separator 203 outputs, from signals inputted from receiver 202, a signal on a PDSCH resource to demodulator/decoder 205.

For example, DCI detector 204 may detect DCI from the signal (e.g., signal on PDCCH resource) inputted from signal separator 203. DCI detector 204 may output the detected DCI to controller 206, for example.

For example, demodulator/decoder 205 performs demodulation and error correction decoding on the signal (e.g., signal on PDSCH resource) inputted from signal separator 203, and obtain at least one of downlink data and a higher layer signal such as system information. For example, demodulator/decoder 205 may output the higher layer signal obtained by decoding to controller 206.

For example, controller 206 may determine (or identify) at least one configuration of an initial UL BWP and/or RO based on the higher layer signal (e.g., system information) inputted from demodulator/decoder 205. Further, for example, controller 206 may indicate information on the RO to signal mapper 209 based on the identified RO. Further, controller 206 may indicate generation of a random access preamble to random access preamble generator 207.

Random access preamble generator 207 generates a random access preamble in accordance with the indication of controller 206 and outputs the generated random access preamble to signal mapper 209.

Encoder/modulator 208 may, for example, encode and modulate uplink data (e.g., PUSCH) and output the modulated signal to signal mapper 209.

For example, signal mapper 209 may map the random access preamble inputted from random access preamble generator 207 to the RO based on the information on RO inputted from controller 206. Further, for example, signal mapper 209 may map the signal inputted from encoder/modulator 208 to a PUSCH resource. Signal mapper 209 outputs the signal mapped to each resource to transmitter 210.

Transmitter 210 performs radio transmission processing including frequency conversion (e.g., up-conversion) on the signal inputted from signal mapper 209, and outputs the signal after the radio transmission processing to antenna 201, for example.

### [Exemplary Operation of Base Station 100 and Terminal 200]

Next, an exemplary operation of above-described base station 100 and terminal 200 will be described.

### <Operation Example 1>

In Operation example 1, base station 100 and terminal 200 may configure a combination of SSB indexes associated with ROs for a non-RedCap terminal to be SSB indexes associated with ROs for a RedCap terminal in the same time-resource. In other words, the combination of SSB indexes associated with ROs for a non-RedCap terminal and the combination of SSB indexes associated with ROs for a RedCap terminal may be configured to be the same in the same time-resource.

For example, base station 100 and terminal 200 may configure the number of SSBs per RO for a RedCap terminal or the number of FDMed ROs for a RedCap terminal so that the combination of SSB indexes configured to ROs for a RedCap terminal and the combination of SSB indexes configured to ROs for a non-RedCap terminal are the same in the same time-resource.

This configuration can reduce the complexity of base station 100 to which a RedCap terminal is connected.

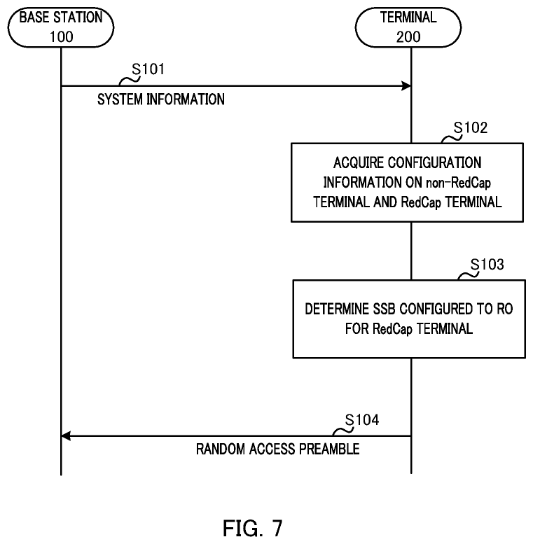

FIG. 7 is a sequence diagram illustrating an exemplary operation of base station 100 and terminal 200. In FIG. 7, terminal 200 may be a RedCap terminal, for example.

### <S101>

For example, base station 100 may determine at least one of an initial UL BWP and/or RO configured for each of a non-RedCap terminal and a RedCap terminal and may indicate configuration information on the determined initial UL BWP and RO to terminal 200 using system information. Note that the configuration information on the initial UL BWP and RO is not limited to be indicated using the system information (e.g., SIB) and may be indicated to terminal 200 using another signal.

### <S102>

Terminal 200 may acquire the configuration information on each of a non-RedCap terminal and a RedCap terminal based on the received system information, for example.

For example, terminal 200 may acquire the bandwidth of the initial UL BWP for a non-RedCap terminal and the RO configuration in the initial UL BWP. The RO configuration for a non-RedCap terminal may include, for example, information on a time resource, a frequency resource, the number of FDMed ROs, and the number of SSB indexes configured per RO.

Further, terminal 200 may acquire the bandwidth of the initial UL BWP for a RedCap terminal and the RO configuration in the initial BWP. The RO configuration for a RedCap terminal may include, for example, a time resource, a frequency resource, and the number of FDMed ROs.

### <S103>

Terminal 200 may determine (e.g., derive) SSBs (e.g., the number of SSB indexes per RO) configured to ROs for a RedCap terminal based on, for example, the RO configuration for a non-RedCap terminal and the RO configuration for a RedCap terminal, for example. For example, terminal 200 may derive the number of SSB indexes per RO for a RedCap terminal so that the combination of SSB indexes configured to ROs for a RedCap terminal and the combination of SSB indexes configured to ROs for a non-RedCap terminal may be the same in one time-resource.

### <S104>

Terminal 200 transmits a random access preamble to base station 100 in the determined RO.

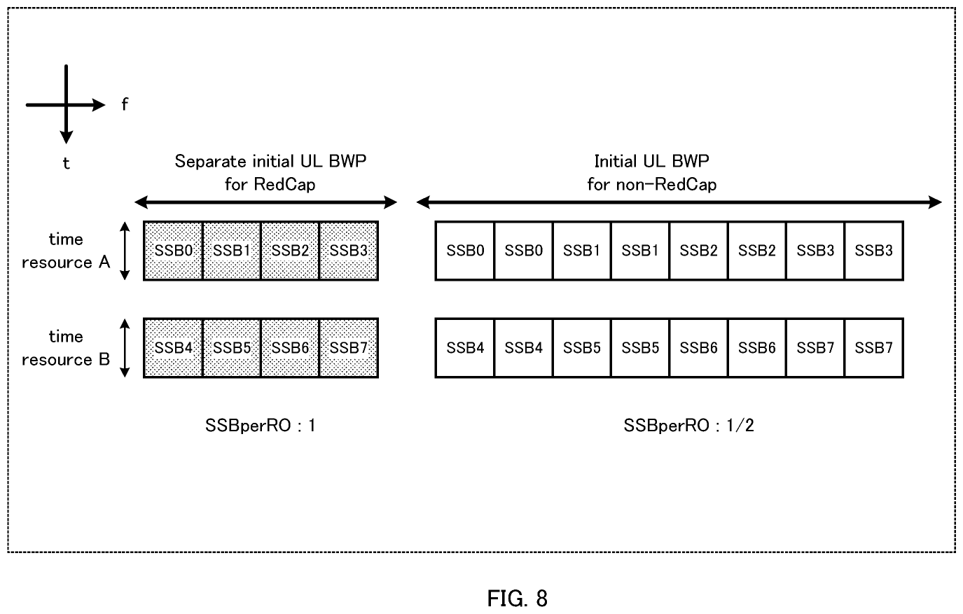

FIG. 8 illustrates exemplary RO configurations for a non-RedCap terminal and a RedCap terminal in Operation example 1.

In FIG. 8, for ROs for a non-RedCap terminal, “the number of FDMed ROs=8 and the number of SSB indexes (SSBperRO)=½” is configured by configuration information. In this case, as illustrated in FIG. 8, SSB indexes 0 to 3 (e.g., SSB0 to SSB3) may be configured to non-RedCap ROs in time resource A, and SSB indexes 4 to 7 (e.g., SSB4 to SSB7) may be configured to non-RedCap ROs in time resource B.

Further, in FIG. 8, for example, for ROs for a RedCap terminal, “the same time-resource as for non-RedCap ROs, and the number of FDMed ROs=4” is configured by configuration information.

In FIG. 8, terminal 200 may determine the number of SSB indexes per RO (SSBperRO) for a RedCap terminal to be one. For example, when the number of SSB indexes per RO is one, one SSB index may be configured to one RO as illustrated in FIG. 8.

Thus, as illustrated in FIG. 8, SSB indexes 0 to 3 (e.g., SSB0 to SSB3) may be configured to RedCap ROs in time resource A and SSB indexes 4 to 7 (e.g., SSB4 to SSB7) may be configured to RedCap ROs in time resource B, based on the number of FDMed ROs=4 for a RedCap terminal and the number of SSB indexes per RO=1.

As illustrated in FIG. 8, the combination of SSB indexes associated with ROs for a RedCap terminal is the same as the combination of SSB indexes associated with ROs for a non-RedCap terminal in a certain time resource (e.g., each of time resource A and time resource B).

For example, in FIG. 8, base station 100 may receive a random access preamble from each of a RedCap terminal and a non-RedCap terminal in beam ranges corresponding to SSB0 to SSB3 in time resource A. In other words, in FIG. 8, base station 100 need not perform reception processing in beam ranges corresponding to SSB4 to SSB7 in time resource A.

Similarly, for example, in FIG. 8, base station 100 may receive a random access preamble from each of a RedCap terminal and a non-RedCap terminal in beam ranges corresponding to SSB4 to SSB7 in time resource B. In other words, in FIG. 8, base station 100 need not perform reception processing in beam ranges corresponding to SSB0 to SSB3 in time resource B.

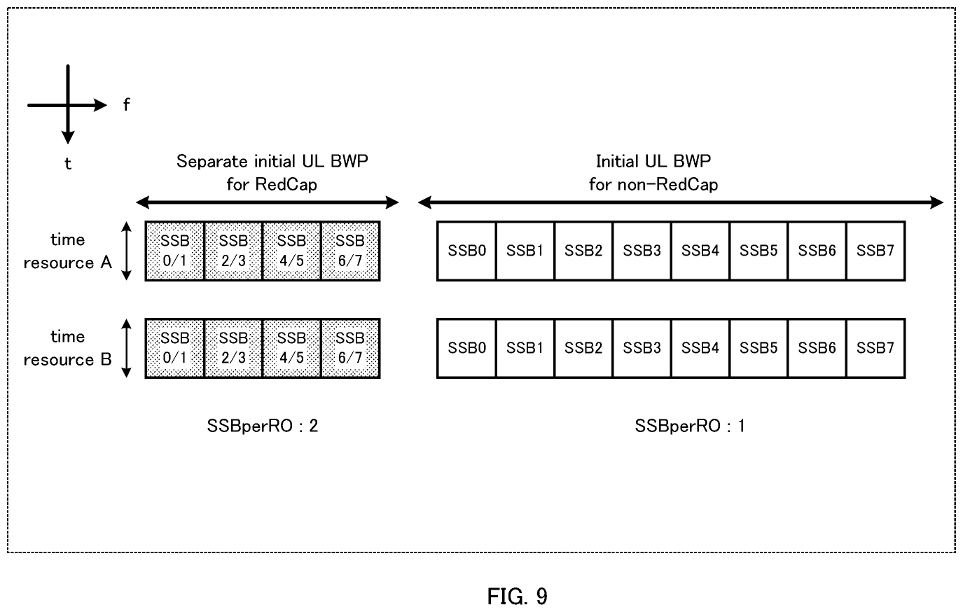

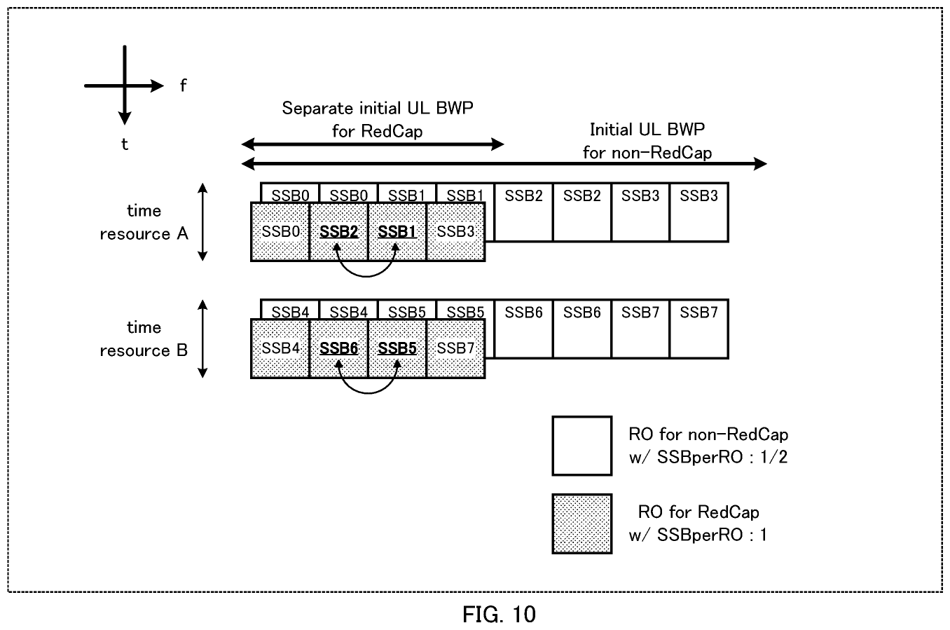

Next, FIG. 9 illustrates other exemplary RO configurations for a non-RedCap terminal and a RedCap terminal in Operation example 1.

In FIG. 9, for ROs for a non-RedCap terminal, “the number of FDMed ROs=8 and the number of SSB indexes (SSBperRO)=1” is configured by configuration information. In this case, as illustrated in FIG. 9, SSB indexes 0 to 7 (e.g., SSB0 to SSB7) may be configured to non-RedCap ROs in each of time resources A and B.

Further, in FIG. 9, for example, for ROs for RedCap terminals, “the same time-resource as for non-RedCap ROs, and the number of FDMed ROs=4” is configured by configuration information.

In FIG. 9, terminal 200 may determine the number of SSB indexes per RO (SSBperRO) for a RedCap terminal to be two. For example, as illustrated in FIG. 9, when the number of SSB indexes per RO is more than one, a plurality of SSB indexes (two in FIG. 9) may be configured to one RO.

Accordingly, as illustrated in FIG. 9, SSB indexes 0 to 7 (e.g., SSB0 to SSB7) may be configured to RedCap ROs in each of time resources A and B, based on the number of FDMed ROs=4 for a RedCap terminal and the number of SSB indexes per RO=2.

As illustrated in FIG. 9, the combination of SSB indexes associated with ROs for a RedCap terminal is the same as the combination of SSB indexes associated with ROs for a non-RedCap terminal in a certain time resource (e.g., each of time resource A and time resource B).

For example, in FIG. 9, base station 100 may receive a random access preamble from each of a RedCap terminal and a non-RedCap terminal in beam ranges corresponding to SSB0 to SSB7 in each of time resources A and B.

As described above, base station 100 and terminal 200 may determine the RO configuration for a RedCap terminal based on the RO configuration for a non-RedCap terminal. For example, base station 100 and terminal 200 may determine (e.g., adjust) the number of SSB indexes per RO for a RedCap terminal.

In Operation example 1, a combination of SSB indexes corresponding to ROs for a RedCap terminal and a combination of SSB indexes corresponding to ROs for a non-RedCap terminal are the same in one time-resource. Accordingly, base station 100 can, for example, receive random access preambles from a plurality of terminals 200 in the same beam-direction regardless of whether terminal 200 is a RedCap terminal or a non-RedCap terminal. In other words, base station 100 need not perform an operation of switching a beam range for receiving a random access preamble depending on the RO configurations for a RedCap terminal and a non-Redcap terminal.

Therefore, according to Operation example 1, it is possible to suppress an increase in the complexity of base station 100.

Note that, in Operation example 1, a case has been described where the number of FDMed ROs is provided for ROs for RedCap terminals to terminal 200 as configuration information in the process of S102 illustrated in FIG. 7, and the number of SSBs per RO is derived based on the number of FDMed ROs in the process of S103 illustrated in FIG. 7, but the present disclosure is not limited thereto. For example, the number of SSBs per RO may be provided for ROs for RedCap terminals to terminal 200 as configuration information in the process of S102 illustrated in FIG. 7, and the number of FDMed ROs may be derived based on the number of SSBs per RO in the process of S103 illustrated in FIG. 7. Further, a parameter provided to terminal 200 in the process of S102 illustrated in FIG. 7 and a parameter derived in the process of S103 illustrated in FIG. 7 are not limited to the above-described examples.

Further, in Operation example 1, cases have been described where the number of SSBs per RO for a RedCap terminal is one in FIG. 8 and the number of SSBs per RO for a RedCap terminal is more than one in FIG. 9, but the number of SSBs per RO for a RedCap terminal may be less than one. When the number of SSBs per RO is less than one, one SSB index may be configured to a plurality of ROs, for example.

Further, in Operation example 1, some or all of frequency resources of ROs for a RedCap terminal may overlap with frequency resources of ROs for a non-RedCap terminal. In this case, an SSB index corresponding to the RO for a non-RedCap terminal and an SSB index corresponding to the RO for a RedCap terminal may be configured to be the same as each other in the same time-resource and the same frequency-resource. For example, the order of SSB indexes configured to ROs for a RedCap terminal may be partially switched, and the same SSB may be configured to the RO present in a frequency in which an RO for a RedCap terminal and an RO for a non-RedCap terminal overlap with each other.

FIG. 10 illustrates exemplary RO configurations for a non-RedCap terminal and a RedCap terminal. In FIG. 10, ROs for a RedCap terminal (the number of times of FDM=4) overlap with some of ROs for a non-RedCap terminal.

For example, as illustrated in FIG. 10, SSB index 1 and SSB index 2 configured to ROs for a RedCap terminal in time resource A may be switched and configured. In other words, as illustrated in FIG. 10, SSB indexes associated with ROs in a time resource need not be configured in ascending order in frequency domain. Thus, in time resource A, the same SSB1 is configured to the RO present in the same frequency resource for each of a RedCap terminal and a non-RedCap terminal.

Similarly, for example, as illustrated in FIG. 10, SSB index 5 and SSB index 6 configured to ROs for a RedCap terminal in time resource B may be switched and configured. Thus, in time resource B, the same SSB5 is configured to the RO for each of a RedCap terminal and a non-RedCap terminal present in the same frequency resource.

By configuring the same SSB index to the RO present in the same frequency resource, the same reception beam can be applied by base station 100, which can improve reception accuracy of a random access preamble in the RO.

Further, in Operation example 1, as illustrated in FIGS. 8, 9, and 10, a case has been exemplarily described where all of the time resources in which ROs for a RedCap terminal are configured are the same as the time resources in which ROs for a non-RedCap terminal are configured, but the present disclosure is not limited thereto, and some of the time resources in which ROs for a RedCap terminals are configured may be different from the time resources in which ROs for a non-RedCap terminal are configured.

### <Operation Example 2>

In Operation example 2, base station 100 and terminal 200 may configure some (subset) of SSB indexes associated with ROs for a non-RedCap terminal in one time-resource (e.g., first time-resource) to SSB indexes associated with ROs for a RedCap terminal in one time-resource, for example.

Further, in Operation example 2, for example, base station 100 and terminal 200 may configure other SSB indexes (or remaining SSB indexes) different from above-described some of SSB indexes among SSB indexes associated with ROs for a non-RedCap terminal, to ROs (e.g., additional ROs) for a RedCap terminal in the second time resource different from the first time resource.

This configuration can reduce the complexity of base station 100 to which a RedCap terminal is connected, and can also increase the number of available preambles per SSB for a RedCap terminal.

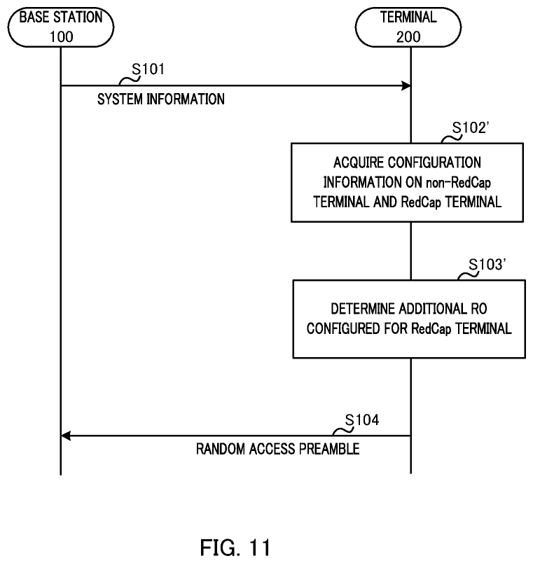

FIG. 11 is a sequence diagram illustrating exemplary processing of base station 100 and terminal 200. In FIG. 11, terminal 200 may be a RedCap terminal, for example.

For example, configuration information on a RedCap terminal received by terminal 200 in S102′ illustrated in FIG. 11 is different from the configuration information on a RedCap terminal received by terminal 200 in Operation example 1 (S102). Further, the process of S103′ illustrated in FIG. 11 is different from the process of Operation example 1 (S103). Furthermore, other processes (e.g., S101 and S104) illustrated in FIG. 11 may be the same as those in Operation example 1.

### <S102′>

Terminal 200 may acquire configuration information on each of a non-RedCap terminal and a RedCap terminal based on the received system information, for example.

For example, terminal 200 may acquire the bandwidth of the initial UL BWP for a non-RedCap terminal and the RO configuration in the initial UL BWP. The RO configuration for a non-RedCap terminal may include, for example, information on a time resource, a frequency resource, the number of FDMed ROs, and the number of SSB indexes configured per RO.

Further, terminal 200 may acquire the bandwidth of the initial UL BWP for a RedCap terminal and the RO configuration in the initial BWP. The RO configuration for a RedCap terminal may include, for example, information on a frequency resource, the number of FDMed ROs, and the number of SSB indexes configured per RO.

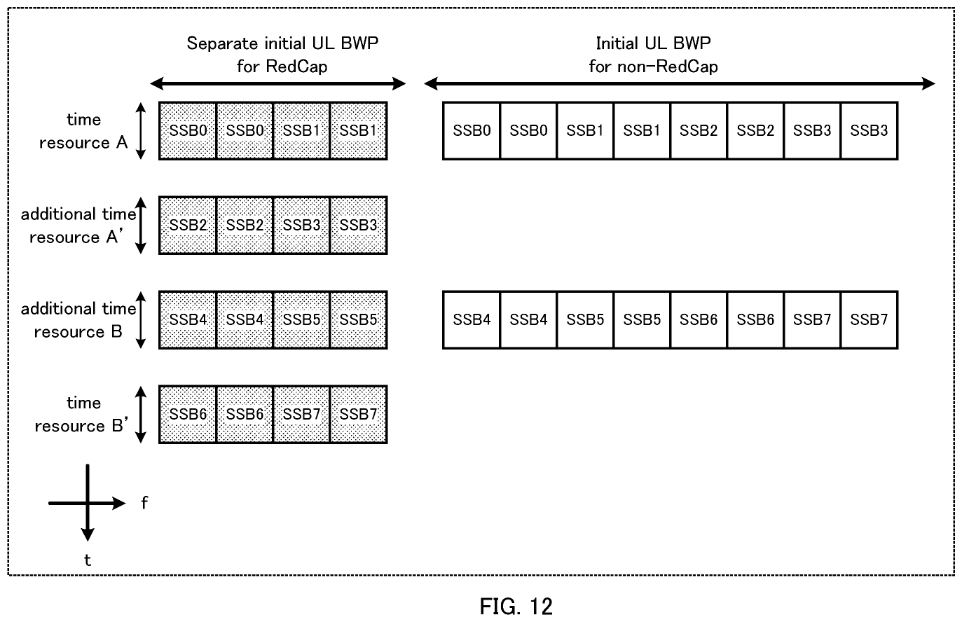

FIG. 12 illustrates exemplary RO configurations for a non-RedCap terminal and a RedCap terminal in Operation example 2.

In FIG. 12, for ROs for a non-RedCap terminal, “the number of FDMed ROs=8 and the number of SSB indexes (SSBperRO)=½” is configured by configuration information. In this case, as illustrated in FIG. 12, SSB indexes 0 to 3 (e.g., SSB0 to SSB3) may be configured to non-RedCap ROs in time resource A, and SSB indexes 4 to 7 (e.g., SSB4 to SSB7) may be configured to non-RedCap ROs in time resource B.

Further, in FIG. 12, for ROs for a RedCap terminal, “the number of FDMed ROs=4 and the number of SSB indexes=½” is configured by configuration information. For example, when the number of SSB indexes per RO is one, one SSB index may be configured to one RO as illustrated in FIG. 8.

### <S103′>

Terminal 200 may determine (e.g., derive) a parameter (e.g., time resource and/or SSB index corresponding to RO) on an additional RO for a RedCap terminal based on the RO configuration for a non-RedCap terminal and the RO configuration for a RedCap terminal, for example.

For example, terminal 200 may determine SSB indexes for a RedCap terminal so that a combination of SSB indexes configured to ROs for RedCap terminals in a time resource in which ROs are configured and in a time resource in which additional ROs are configured and a combination of SSB indexes configured to ROs for non-RedCap terminals in one time-resource are the same as each other.

For example, terminal 200 may determine SSB indexes configured to ROs for a RedCap terminal in one time-resource to be some (subset) of SSB indexes in the combination of SSB indexes configured to ROs for a non-RedCap terminal in one time-resource.

Further, terminal 200 may determine SSB indexes configured to additional ROs for a RedCap terminal in one time-resource to be remaining SSB indexes in the combination of SSB indexes configured to ROs for a non-RedCap terminal in one time-resource. For example, terminal 200 may configure an additional time resource in addition to the time resource for a non-RedCap terminal, for a RedCap terminal.

For example, as illustrated in FIG. 12, terminal 200 may configure SSB indexes 0 to 1 (SSB0 and SSB1) to RedCap ROs in time resource A and SSB indexes 4 to 5 (SSB4 and SSB5) to RedCap ROs in time resource B. Further, in FIG. 12, terminal 200 (RedCap terminal) may determine the configuration of additional ROs in time resources A‘ and B’ different from time resources A and B. Further, as illustrated in FIG. 12, terminal 200 may configure, among remaining SSB indexes of the SSB indexes configured to ROs for a non-RedCap terminal, SSB indexes 2 to 3 (SSB2 and SSB3) to additional ROs in time resource A′ and SSB indexes 6 to 7 (SSB6 and SSB7) to additional ROs in time resource B′.

As illustrated in FIG. 12, the combination of SSB indexes associated with ROs and additional ROs for a RedCap terminal in time resource A and time resource A′ is the same as the combination of SSB indexes associated with ROs for a non-RedCap terminal in time resource A. Similarly, as illustrated in FIG. 12, the combination of SSB indexes associated with ROs and additional ROs for a RedCap terminal in time resource B and time resource B′ is the same as the combination of SSB indexes associated with ROs for a non-RedCap terminal in time resource B.

As described above, base station 100 and terminal 200 may determine the RO configuration for a RedCap terminal based on the RO configuration for a non-RedCap terminal.

In Operation example 2, a combination of SSB indexes corresponding to ROs for a RedCap terminal is configured to be a part (subset) of a combination of SSB indexes corresponding to ROs for a non-RedCap terminal in one time-resource. Thus, base station 100 can, for example, receive a random access preamble from a RedCap terminal in the same beam direction (e.g., at least coarse direction) in the one time-resource. For example, as illustrated in FIG. 12, base station 100 can configure beam ranges corresponding to SSBs associated with ROs for a RedCap terminal in each time resource to be within beam ranges corresponding to SSBs associated with ROs for a non-RedCap terminal in one time-resource. Accordingly, base station 100 does not need to perform beamforming in a plurality of ranges in order to receive a random access preamble from a RedCap terminal.

Further, for example, in FIG. 12, in time resources A and B, base station 100 can receive a random access preamble from each of a Redcap terminal and a non-RedCap terminal in beam ranges corresponding to the combination of SSB0 to SSB3 or the combination of SSB4 to SSB7. As described above, base station 100 can, for example, receive random access preambles from a plurality of terminals 200 in the same beam-direction regardless of whether terminal 200 is a RedCap terminal or a non-RedCap terminal. In other words, base station 100 need not perform an operation of switching a beam range for receiving a random access preamble depending on the RO configurations for a RedCap terminal and a non-Redcap terminal.

Therefore, according to Operation example 2, it is possible to suppress an increase in the complexity of base station 100.

Further, according to Operation example 2, the number of ROs available for a RedCap terminal increases due to the addition of ROs, and the number of available preambles also increases in association with SSBs, so that the probability of collisions of preambles between terminals 200 can be reduced.

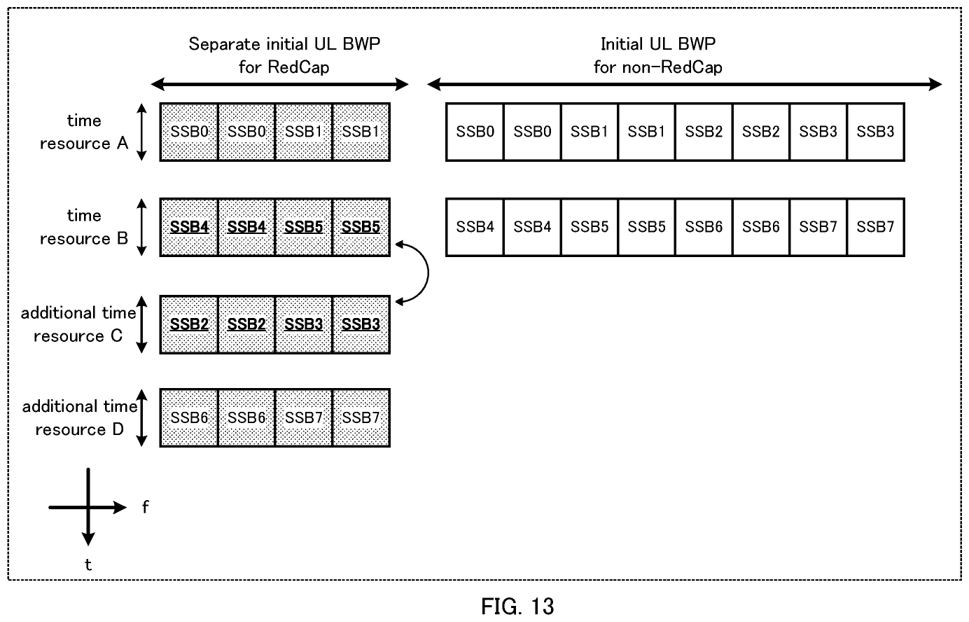

Note that the time resource in which additional ROs for a RedCap terminal is configured is not limited to the time resource illustrated in FIG. 12. For example, the RedCap terminal may determine that an additional RO is present in a time resource (e.g., time resources C and D) before or after time resources A and B (e.g., same time resource as ROs for a non-RedCap terminal). At this time, in the time resource in which ROs for a non-RedCap terminal are configured, SSB indexes associated with ROs for a RedCap terminal may be configured to be any of SSB indexes associated with ROs for a non-RedCap terminal. For example, as illustrated in FIG. 13, SSBs (SSB indexes) corresponding to ROs for a RedCap terminal may be switched between time resources B and C. As a result, SSB indexes (SSB4 and SSB5) configured to ROs for a RedCap terminal in time resource B become the same as some of SSB indexes (SSB4 to SSB7) configured to ROs for a non-RedCap terminal in time resource B as illustrated in FIG. 13, which can reduce an increase in the complexity of base station 100.

Note that, in FIG. 13, a case has been described in which SSB indexes configured to ROs for a RedCap terminal are switched between time resource B (e.g., SSB2 and SSB3) and time resource C (e.g., SSB4 and SSB5), but the present disclosure is not limited thereto, and SSB indexes configured to ROs for a RedCap terminal may be switched between time resource B (e.g., SSB2 and SSB3) and time resource D (e.g., SSB6 and SSB7), for example.

Further, in FIG. 13, a case has been described in which additional time resources C and D are configured after time resources A and B, but the present disclosure is not limited thereto, and the additional time resource may be configured to at least one of before and/or after time resources A and B.

Further, information on the time resource (e.g., at least one of time resources A to D in FIG. 12 or 13) in which ROs for a RedCap terminal are configured may be indicated from base station 100 to terminal 200, or may be determined based on the RO configuration information on at least one of a non-RedCap terminal and/or a RedCap terminal. For example, in FIG. 12 and FIG. 13, information on time resources A and B for a RedCap terminal may be indicated from base station 100 to terminal 200, or may be identified based on the time resource in which ROs for a non-RedCap terminal are configured. Further, for example, information on the additional time resource illustrated in FIGS. 12 and 13 may be indicated from base station 100 to terminal 200, identified based on the time resource in which ROs for a non-RedCap terminal are configured, or identified based on another time resource (e.g., time resources A and B) in which ROs for a RedCap terminal are configured.

Further, the quantity (e.g., number) of time resources in which additional ROs configured for a RedCap terminal are configured is not limited to two as illustrated in FIGS. 12 and 13, and may be one, three, or more. For example, the quantity of time resources in which additional ROs are configured may be determined based on the configuration information on ROs for a RedCap terminal and a non-RedCap terminal, or indicated from base station 100 to terminal 200.

The exemplary operations of base station 100 and terminal 200 have been described above.

As described above, in the present embodiment, base station 100 and terminal 200 configure some or all of SSB indexes associated with ROs for a non-RedCap terminal in one time-resource, for SSB indexes associated with ROs for a RedCap terminal in one time resource.

According to this SSB index configuration, even when ROs (or initial UL BWP) configured for a non-RedCap terminal and ROs configured for a RedCap terminal are different from each other, the same combination of SSB indexes can be configured to ROs configured for a RedCap terminal as configured to ROs for a non-RedCap terminal. This allows base station 100 to configure the same receivable beam range for a non-RedCap terminal and a RedCap terminal. Therefore, according to the present embodiment, it is possible to improve processing efficiency in base station 100 to which terminal 200 is connected.

The embodiment of the present disclosure has been described above.

### OTHER EMBODIMENTS

### (Application/Non-application of Operation)

Base station 100 may indicate, to a RedCap terminal, information (e.g., information on a configuration of association between an RO and an SSB index) on whether to apply either of Operation examples 1 and 2 or both of them by using a control signal such as RRC or DCI, for example.

Terminal 200 may determine an RO configuration of a RedCap terminal based on the indicated control signal, for example.

For example, in a case of non-application of Operation example 1, the number of SSBs per RO for a RedCap terminal may be the same as the number of SSBs per RO for a non-RedCap terminal.

Further, for example, in a case of non-application of Operation example 2, no additional RO for a RedCap terminal may be configured.

This can improve flexibility in RO configuration (e.g., SSB index configuration or time resource configuration) for a RedCap terminal, for example.

(Method for Determining each RO Parameter)

In Operation example 1 or 2 described above, based on either of the number of FDMed ROs for a RedCap terminal in one time-resource and the number of SSB indexes per RO for a RedCap terminal and a parameter on RO configuration for a non-RedCap terminal, terminal 200 may determine the other of the number of FDMed ROs for a RedCap terminal in one time-resource and the number of SSB indexes per RO for a RedCap terminal.

For example, the number of SSBs per RO for a RedCap terminal may be determined using at least one of {the number of FDMed ROs for a non-RedCap terminal, the number of FDMed ROs for a RedCap terminal, and/or the number of SSBs per RO for a non-RedCap mobile station}.

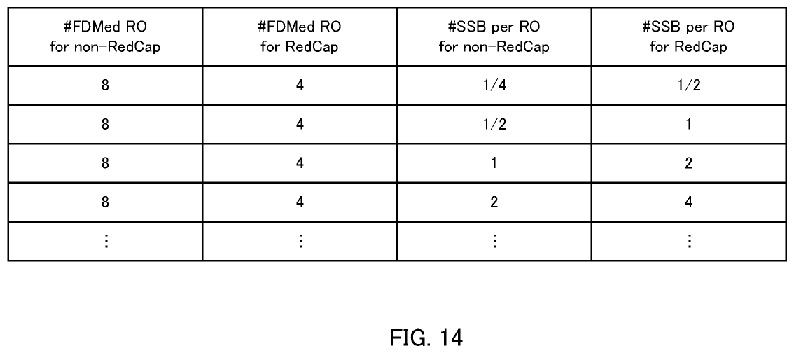

For example, the association relation between the number of SSBs per RO for a RedCap terminal and {the number or FDMed RO for a non-RedCap terminal, the number of FDMed ROs for a RedCap terminal, and/or the number of SSBs per RO for a non-RedCap terminal} may be represented by table-format information as illustrated FIG. 14. Such information may be specified in advance in the standard, or may be indicated from base station 100 to terminal 200 by a control signal.

Alternatively, the number of SSBs per RO for a RedCap terminal may be calculated in accordance with the following Equation 1. Equation 1 may be specified in advance in the standard, or may be indicated from base station 100 to terminal 200 by a control signal.

$${SSBperRO}_{RedCap} = \frac{{FDMedRO}_{nonRedCap}}{{FDMedRO}_{RedCap}} {SSBperRO}_{nonRedCap} \qquad ( Equation 1 )$$

Each parameter in Equation 1 is as follows:
SSBperRO_{Redcap}: The number of SSBs per RO for a RedCap terminal;
FDMedRO_{nonRedcap}: The number of FDMed ROs for a non-RedCap terminal;
FDMedRO_{Redcap}: The number of FDMed ROs for a RedCap terminal; and
SSBperRO_{nonRedcap}: The number of SSBs per RO for a non-RedCap terminal.

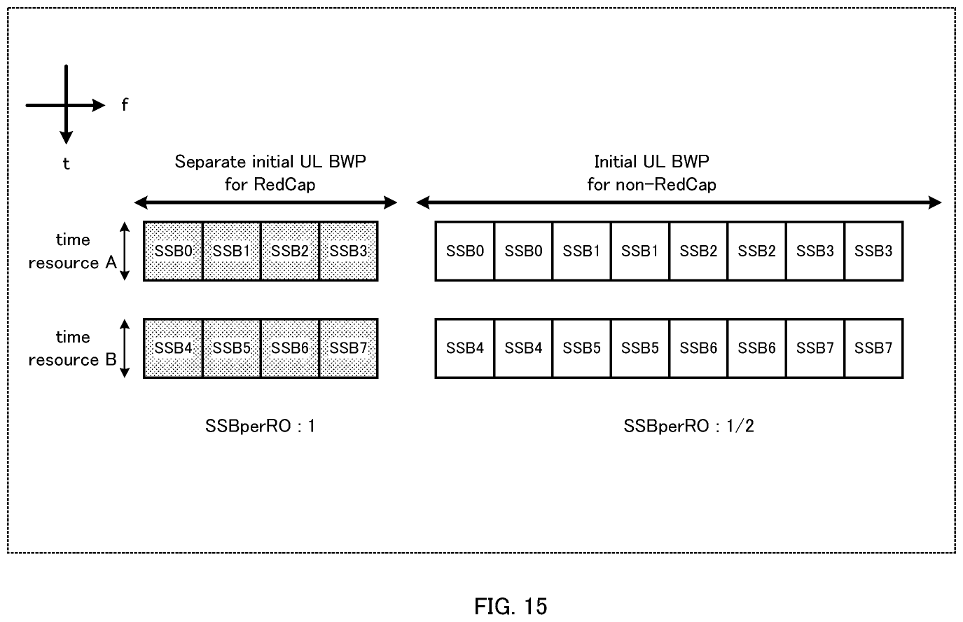

For example, as illustrated in FIG. 15, when FDMedRO_{nonRedcap} (the number of FDMed ROs for a non-RedCap terminal)=8, FDMedRO_{Redcap} (the number of FDMed ROs for a RedCap terminal)=4, and SSBperRO_{nonRedcap} (the number of SSBs per RO for a non-RedCap terminal)=½, terminal 200 may determine SSBperRO_{RedCap} (the number of SSBs per RO for a RedCap terminal)=1 in accordance with the association relation in FIG. 14 or Equation 1.

Note that, in the above-described example, a case has been described in which the number of SSBs per RO for a RedCap terminal is derived from other parameters, but the present disclosure is not limited thereto. For example, the number of FDMed ROs for a RedCap terminal may be determined using at least one value of {the number of FDMed ROs for a non-RedCap terminal, the number of SSBs per RO for a RedCap terminal, and/or the number of SSBs per RO for a non-RedCap terminal}. Further, the parameter determined in RO configuration for a RedCap terminal and the parameter used for the determination are not limited to the above-described examples.

For example, instead of the number of FDMed ROs for a non-RedCap terminal, a bandwidth in which an RO for a non-RedCap terminal is configured or a bandwidth (e.g., initial UL BWP) configured for a non-RedCap terminal may be used. For example, instead of the number of FDMed ROs for a RedCap terminal, a bandwidth in which an RO for a RedCap terminal is configured or a bandwidth (e.g., separate initial UL BWP) configured for a RedCap terminal may be used.

A parameter herein used for determination of a certain parameter may be specified in advance in the standard or may be indicated from base station 100 to terminal 200 using a control signal. For example, the RO parameter configuration for a non-RedCap terminal may be specified in the standard or may be indicated to terminal 200 by a control signal, and the RedCap terminal may derive the RO parameter configuration for the RedCap terminal using the value.

Further, for example, terminal 200 may determine the RO configuration for a RedCap terminal such as the number of FDMed ROs and the number of SSBs per RO in accordance with the above-described method (e.g., Equation 1 or table) and may configure SSB indexes to the ROs. For the SSB index configuration, similarly to the above-described Operation example or variation, SSB indexes in ROs for a RedCap terminal may be determined based on SSB indexes in ROs for a non-RedCap terminal or may be determined independent of SSB indexes in ROs for a non-RedCap terminal.

### (Shared RO)

In the above-described Operation examples, it is assumed that ROs are configured for a RedCap terminal and a non-RedCap terminal separately, but the present disclosure is not limited thereto. For example, at least one of ROs for a RedCap terminal may be included in ROs for a non-RedCap terminal. In other words, at least one of ROs for a non-RedCap terminal may be used as an RO for a RedCap terminal.

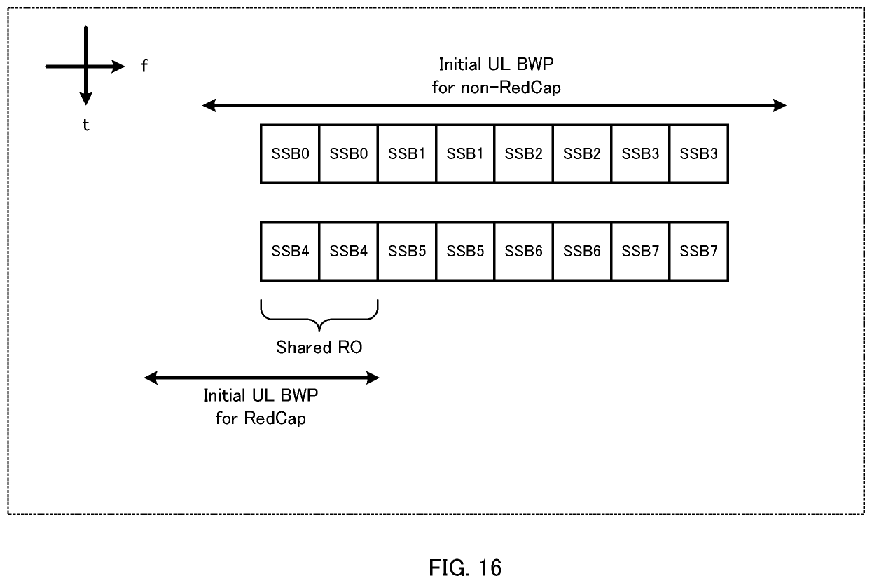

For example, as illustrated in FIG. 16, at least a part of the initial UL BWP for a RedCap terminal may overlap with the initial UL BWP for a non-RedCap terminal in frequency domain. In this case, as illustrated in FIG. 16, among ROs for a non-RedCap terminal, ROs (overlapping ROs) included in the BWP for a RedCap terminal may be referred to as “shared RO.” The shared RO may be assumed to be used also as an RO for a RedCap terminal, for example. The above-described Operation examples may be applied to a shared RO, for example.

Note that the RO overlapping between RedCap and non-RedCap described above may be defined by a term different from the shared RO.

Further, ROs for RedCap terminals may be constituted by Shared ROs or may be constituted by a Shared RO and another RO different from the Shared RO.

### (Terminal Type and Identification)

The above-described embodiments may be applied to, for example, a “RedCap terminal” or anon RedCap terminal.

Note that the RedCap terminal may be, for example, a terminal having at least one of the following characteristics (in other words, attributes or capabilities).

(1) A terminal that indicates (e.g., report), to base station 100, that the terminal is “a terminal targeted for coverage enhancement,” “a terminal that receives a signal repeatedly transmitted,” or “a RedCap terminal.” Note that, for the above-described indication (report), an uplink channel such as a PRACH and a PUSCH, uplink control information (UCI), or an uplink signal such as a Sounding Reference Signal (SRS) may be used, for example.

(2) A terminal having at least one of the following capabilities, or a terminal reporting at least one of the following capabilities to base station 100. Note that, for the above-described report, an uplink channel such as a PRACH and a PUSCH or an uplink signal such as UCI or an SRS may be used, for example.
A terminal whose supportable frequency bandwidth is equal to or less than a threshold value (e.g., 20 MHz, 40 MHz, or 100 MHz)
A terminal in which the number of implemented reception antennae is equal to or less than a threshold value (e.g., threshold=1)
A terminal in which the number of supportable downlink ports (e.g., the number of reception antenna ports) is equal to or less than a threshold value (e.g., threshold value=2)
A terminal in which the number of supportable number of transmission ranks (e.g., the number of maximum Multiple-Input Multiple-Output (MIMO) layers (or the number of ranks) is equal to or less than a threshold value (e.g., threshold value=2)
A terminal capable of transmitting and receiving a signal in a frequency band equal to or higher than a threshold value (e.g., Frequency Range 2 (FR2) or a band equal to or higher than 52 GHz)
A terminal whose processing time is equal to or longer than a threshold value
A terminal in which the available transport block size (TBS) is equal to or less than a threshold value
A terminal in which the number of available transmission ranks (e.g., the number of MIMO transmission layers) is equal to or less than a threshold value.
A terminal whose available modulation order is equal to or less than a threshold value
A terminal in which the number of available Hybrid Automatic Repeat request (HARQ) processes is equal to or less than a threshold value
A terminal that supports Rel-17 NR or later release

(3) A terminal to which a parameter corresponding to a RedCap terminal is indicated from base station 100. Note that the parameter corresponding to the RedCap mobile station may include, for example, a parameter such as a Subscriber Profile ID for RAT/Frequency Priority (SPID).

Note that the term “non-RedCap terminal” may mean, for example, a terminal that supports Rel-15/16 (e.g., a terminal that does not support Rel-17) or a terminal that does not have the above-described characteristics even though the terminal supports Rel-17.

### (Signal/Channel Type)

Note that, in the above-described embodiments, resource allocation for an uplink channel and signal (e.g., random access preamble) has been described, but the above-described embodiments may be applied to a downlink channel and signal (e.g., any of PDCCH and PDSCH) or another uplink channel and signal (e.g., any of PUSCH, PUCCH, and PRACH).

Further, in the above embodiments, an example has been described in which the resource for the data signal (e.g., PDSCH or PUSCH) is assigned to terminal 200 by the PDCCH (e.g., downlink control information), but the present disclosure is not limited thereto, and may be configured by a higher layer signal, for example.

Furthermore, the PDCCH may be transmitted, for example, in either Common Search Space (CSS) or UE Specific Search Space (USS).

Further, the operation in the initial UL BWP has been described in the above embodiments, but the present disclosure is not limited thereto, and an embodiment of the present disclosure may be applied to another allocated band (e.g., BWP of another type).

Furthermore, a configuration on an association between an RO and an SSB index for a RedCap terminal has been described in the embodiments of the present disclosure, but the present disclosure is not limited to the configuration on the association between an RO and an SSB index for a RedCap terminal, and may be applied to a configuration on an association between another resource (or transmission occasion) different from the RO and another signal different from the SSB.

Further, parameter values such as a frequency bandwidth supported by a Redcap terminal and a non-RedCap terminal, the number of FDMed ROs, the number SSB indexes per RO, the number of time resources, the number of SSBs, and the SSB index number applied in the description of the present embodiments are merely examples, and may be other values.

Further, any component termed with a suffix, such as “-er,” “-or,” or “-ar” in the above-described embodiments may be replaced with other terms such as “circuit (circuitry),” “device,” “unit,” or “module.”

### (Supplement)

Information indicating whether terminal 200 supports the functions, operations, or processes described in the above-described embodiments may be transmitted (or indicated) from terminal 200 to base station 100 as capability information or a capability parameter of terminal 200.

The capability information may include an information element (IE) individually indicating whether terminal 200 supports at least one of the functions, operations, or processes described in the above-described embodiments. Alternatively, the capability information may include an information element indicating whether terminal 200 supports a combination of any two or more of the functions, operations, or processes described in the above-described embodiments, modifications, and supplements.

Base station 100 may determine (or assume) the function, operation, or process supported (or not supported) by terminal 200 of the transmission source of the capability information, based on the capability information received from terminal 200, for example. Base station 100 may perform an operation, processing, or control corresponding to a determination result based on the capability information. For example, base station 100 may control the RO configuration based on the capability information received by terminal 200.

Note that the fact that terminal 200 does not support some of the functions, operations, or processes described in the above-described embodiments may be read as that some of the functions, operations, or processes are limited in terminal 200. For example, information or a request on such limitation may be indicated to base station 100.

Information on the capability or limitation of terminal 200 may be defined, for example, in the standard, or may be implicitly indicated to base station 100 in association with information known to base station 100 or information transmitted to base station 100.

### (Control Signal)

In the present disclosure, the downlink control signal (or downlink control information) relating to the exemplary embodiments of the present disclosure may be a signal (or information) transmitted in a Physical Downlink Control Channel (PDCCH) in a physical layer, for example, or may be a signal (or information) transmitted in a Medium Access Control Control Element (MAC CE) or Radio Resource Control (RRC) in a higher layer. Further, the signal (or information) is not limited to that indicated by the downlink control signal, but may be predefined in the specifications (or standard) or may be pre-configured for the base station and the terminal.

In the present disclosure, the uplink control signal (or uplink control information) relating to the exemplary embodiments of the present disclosure may be, for example, a signal (or information) transmitted in a PUCCH of the physical layer or a signal (or information) transmitted in the MAC CE or RRC of the higher layer. In addition, the signal (or information) is not limited to a case of being indicated by the uplink control signal and may be previously specified by the specifications (or standards) or may be previously configured in a base station and a terminal. Further, the uplink control signal may be replaced with, for example, uplink control information (UCI), 1st stage sidelink control information (SCI), or 2nd stage SCI.

### (Base Station)

In the above embodiments, the base station may be a transmission reception point (TRP), a clusterhead, an access point, a remote radio head (RRH), an eNodeB (eNB), a gNodeB (gNB), a base station (BS), a base transceiver station (BTS), a base unit, or a gateway, for example. Further, in side link communication, a terminal may serves as abase station. Furthermore, instead of the base station, a relay apparatus that relays communication between a higher node and a terminal may be used. Moreover, a road side device may be used.

### (Uplink/Downlink/Sidelink)

An exemplary embodiment of the present disclosure may be applied to, for example, any of an uplink, a downlink, and a sidelink. For example, an exemplary embodiment of the present disclosure may be applied to an uplink Physical Uplink Shared Channel (PUSCH), Physical Uplink Control Channel (PUCCH), or Physical Random Access Channel (PRACH), a downlink Physical Downlink Shared Channel (PDSCH), PDCCH, or Physical Broadcast Channel (PBCH), or a sidelink Physical Sidelink Shared Channel (PSSCH), Physical Sidelink Control Channel (PSCCH), or Physical Sidelink Broadcast Channel (PSBCH).

Note that the PDCCH, the PDSCH, the PUSCH, and the PUCCH are examples of a downlink control channel, a downlink data channel, an uplink data channel, and an uplink control channel, respectively. Further, the PSCCH and the PSSCH are examples of a side link control channel and a side link data channel, respectively. Further, the PBCH and PSBCH are examples of a broadcast channel, and the PRACH is an example of a random access channel.

### (Data Channel/Control Channel)

An exemplary embodiment of the present disclosure may be applied to, for example, any of a data channel and a control channel. For example, a channel in an exemplary embodiment of the present disclosure may be replaced with any one of the PDSCH, the PUSCH, and the PSSCH being the data channels, or the PDCCH, the PUCCH, the PBCH, the PSCCH, and the PSBCH being the control channels.

### (Reference Signal)

In an exemplary embodiment of the present disclosure, a reference signal is a signal known to both a base station and a mobile station and may also be referred to as a reference signal (RS) or a pilot signal. The reference signal may be any of a Demodulation Reference Signal (DMRS), a Channel State Information-Reference Signal (CSI-RS), a Tracking Reference Signal (TRS), a Phase Tracking Reference Signal (PTRS), a Cell-specific Reference Signal (CRS), or a Sounding Reference Signal (SRS).

### (Time Intervals)

In an embodiment of the present disclosure, time resource units are not limited to one or a combination of slots and symbols, and may be time resource units, such as frames, superframes, subframes, slots, time slot subslots, minislots, or time resource units, such as symbols, orthogonal frequency division multiplexing (OFDM) symbols, single carrier-frequency division multiplexing access (SC-FDMA) symbols, or other time resource units. The number of symbols included in one slot is not limited to any number of symbols exemplified in the embodiments described above, and may be other numbers of symbols.

### (Frequency Band)

An exemplary embodiment of the present disclosure may be applied to either a licensed band or an unlicensed band (unlicensed spectrum, shared spectrum). A channel access procedure (Listen Before Talk (LBT), carrier sense, and/or Channel Clear Assessment (CCA)) may be performed prior to transmission of each signal.

### (Communication)

An exemplary embodiment of the present disclosure may be applied to any of communication between a base station and a terminal (Uu link communication), communication between a terminal and a terminal (Sidelink communication), and communication of a Vehicle to Everything (V2X). For example, the channel in an exemplary embodiment of the present disclosure may be replaced with the PSCCH, the PSSCH, the Physical Sidelink Feedback Channel (PSFCH), the PSBCH, the PDCCH, the PUCCH, the PDSCH, the PUSCH, or the PBCH.

Further, an exemplary embodiment of the present disclosure may be applied to either terrestrial networks or a non-terrestrial network (NTN) such as communication using a satellite or a high-altitude pseudolite (High Altitude Pseudo Satellite (HAPS)). Further, an exemplary embodiment of the present disclosure may be applied to a terrestrial network having a large transmission delay compared to the symbol length or slot length, such as a network with a large cell size and/or an ultra-wideband transmission network.

### (Antenna Port)

In an exemplary embodiment of the present disclosure, the antenna port refers to a logical antenna (antenna group) configured of one or more physical antennae. For example, the antenna port does not necessarily refer to one physical antenna and may refer to an array antenna or the like configured of a plurality of antennae. In one example, the number of physical antennae configuring the antenna port need not be specified, and the antenna port may be specified as the minimum unit with which a terminal station can transmit a Reference signal. Moreover, the antenna port may be specified as the minimum unit for multiplying a weight of a Precoding vector.

### <5G NR System Architecture and Protocol Stacks>

3GPP has been working at the next release for the 5th generation cellular technology, simply called 5G, including the development of a new radio (NR) access technology operating in frequencies ranging up to 100 GHz. The first version of 5G standard was initially delivered in late 2017, which allows proceeding to trials and commercial deployments of 5G NR standard-compliant terminals, e.g., smartphones.

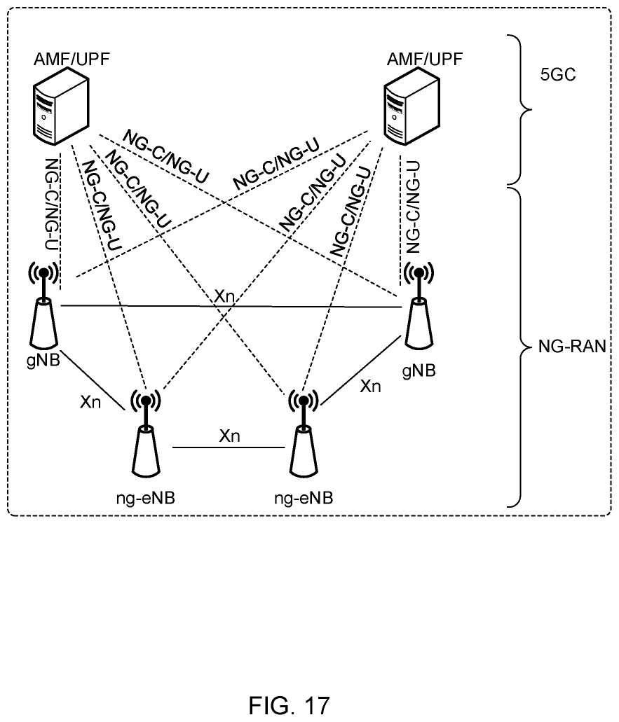

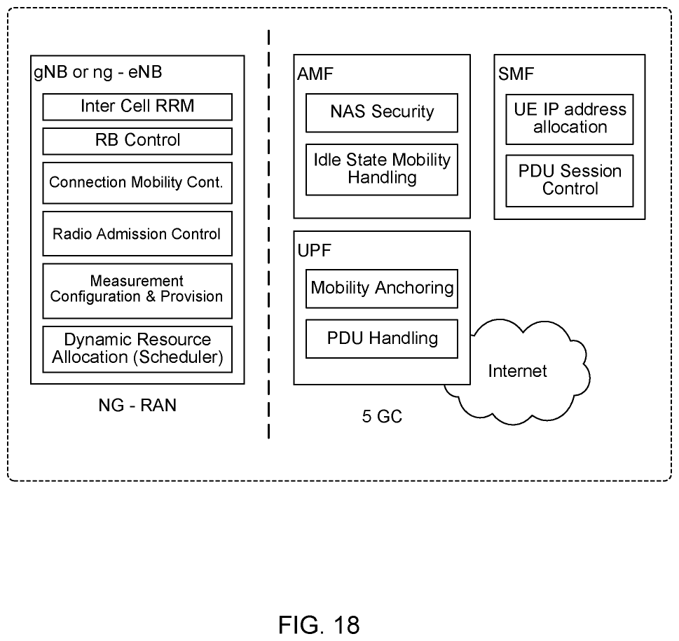

For example, the overall system architecture assumes a Next Generation-Radio Access Network (NG-RAN) that includes gNBs. The gNBs provide the NG-radio access user plane (SDAP/PDCP/RLC/MAC/PHY) and control plane (RRC) protocol terminations towards a UE. The gNBs are interconnected with each other via an Xn interface. The gNBs are also connected to the Next Generation Core (NGC) via the Next Generation (NG) interface, more specifically to the Access and Mobility Management Function (AMF; e.g. a particular core entity performing the AMF) via the NG-C interface, and to the User Plane Function (UPF; e.g., a particular core entity performing the UPF) via the NG-U interface. The NG-RAN architecture is illustrated in FIG. 17 (see, e.g., 3GPP TS 38.300 v15.6.0, section 4).

The user plane protocol stack for NR (see, e.g., 3GPP TS 38.300, section 4.4.1) includes the Packet Data Convergence Protocol (PDCP, see clause 6.4 of TS 38.300) Radio Link Control (RLC, see clause 6.3 of TS 38.300) and Medium Access Control (MAC, see clause 6.2 of TS 38.300) sublayers, which are terminated in the gNB on the network side. Additionally, anew access stratum (AS) sublayer (Service Data Adaptation Protocol: SDAP) is introduced above the PDCP (see, e.g., clause 6.5 of 3GPP TS 38.300). A control plane protocol stack is also defined for NR (see, e.g., TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For example, the Medium-Access-Control layer handles logical-channel multiplexing, and scheduling and scheduling-related functions, including handling of different numerologies.

The physical layer (PHY) is, for example, responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For example, the physical channels include a Physical Random Access Channel (PRACH), Physical Uplink Shared Channel (PUSCH), and Physical Uplink Control Channel (PUCCH) as uplink physical channels, and a Physical Downlink Shared Channel (PDSCH), Physical Downlink Control Channel (PDCCH), and Physical Broadcast Channel (PBCH) as downlink physical channels.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, the eMBB is expected to support peak data rates (20 Gbps for downlink and 10 Gbps for uplink) and user-experienced data rates in the order of three times what is offered by IMT-Advanced. Meanwhile, in a case of the URLLC, the tighter requirements are put on ultra-low latency (0.5 ms for each of UL and DL for user plane latency) and high reliability (1-10-5 within 1 ms). Finally, the mMTC may preferably require high connection density (1,000,000 devices/km² in an urban environment), large coverage in harsh environments, and extremely long-life battery for low cost devices (15 years).

Thus, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (also referred to as TTI) than an mMTC service. Furthermore, deployment scenarios with large channel delay spreads may preferably require a longer CP duration than scenarios with short delay spreads. The subcarrier spacing may be optimized accordingly to retain the similar CP overhead. NR may support more than one value of subcarrier spacing. Correspondingly, subcarrier spacing of 15 kHz, 30 kHz, 60 kHz . . . are currently considered. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR, for each numerology and carrier, a resource grid of subcarriers and OFDM symbols is defined for each of uplink and downlink. Each element in the resource grid is called a resource element and is identified based on the frequency index in the frequency domain and the symbol position in the time domain (see 3GPP TS 38.211 v15.6.0).

### <5G NR Functional Split Between NG-RAN and 5GC>

FIG. 18 illustrates functional split between NG-RAN and 5GC. An NG-RAN logical node is a gNB or ng-eNB. The 5GC has logical nodes AMF, UPF, and SMF.

For example, the gNB and ng-eNB host the following main functions:
Functions for radio resource management such as radio bearer control, radio admission control, connection mobility control, dynamic allocation of resources to UEs in both uplink and downlink (scheduling);
IP header compression, encryption, and integrity protection of data;
Selection of an AMF at UE attachment when no routing to an AMF can be determined from the information provided by the UE;
Routing of user plane data towards UPF(s);
Routing of control plane information towards AMF;
Connection setup and release;
Scheduling and transmission of paging messages;
Scheduling and transmission of system broadcast information (originated from the AMF or Operation, Admission, Maintenance (OAM));
Measurement and measurement reporting configuration for mobility and scheduling;
Transport level packet marking in the uplink;
Session management;
Support of network slicing;
QoS Flow management and mapping to data radio bearers;
Support of UEs in RRC_INACTIVE state;
Distribution function for NAS messages;
Radio access network sharing;
Dual Connectivity; and
Tight interworking between NR and E-UTRA.

The access and mobility management function (AMF) hosts the following main functions:
Non-Access Stratum (NAS) signaling termination function;
NAS signaling security;
Access Stratum (AS) security control;
Inter Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

Furthermore, the user plane function (UPF) hosts the following main functions:
Anchor point for intra-/inter-RAT mobility (when applicable);
External protocol data unit (PDU) session point of interconnect to a data network;
Packet routing and forwarding;
Packet inspection and user plane part of policy rule enforcement;
Traffic usage reporting;
Uplink classifier to support routing traffic flows to a data network;
Branching point to support multi-homed PDU session;
QoS handling for user plane (e.g. packet filtering, gating, and UL/DL rate enforcement);
Uplink traffic verification (SDF to QoS flow mapping); and
Downlink packet buffering and downlink data indication triggering.

Finally, the session management function (SMF) hosts the following main functions:
Session management;
UE IP address allocation and management;
Selection and control of UPF;
Configuration function of traffic steering at a user plane function (UPF) to route traffic to proper destination;
Control part of policy enforcement and QoS; and
Downlink data indication.

### <RRC Connection Setup and Reconfiguration Procedures>

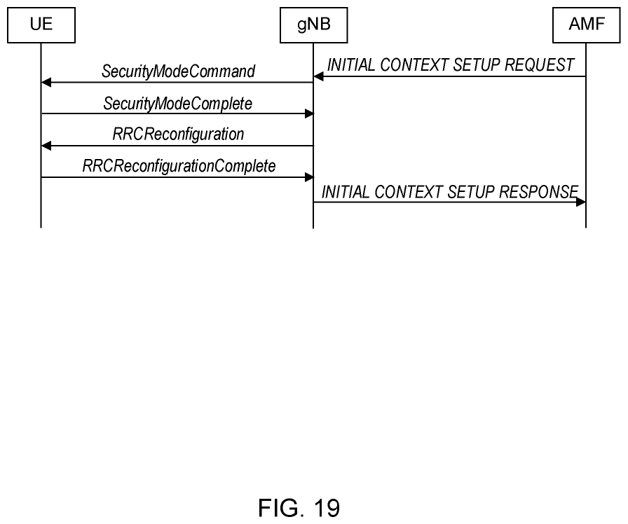

FIG. 19 illustrates some interactions between a UE, gNB, and AMF (a 5GC entity) in the context of a transition of the UE from RRC_IDLE to RRC_CONNECTED for the NAS part (see TS 38.300 v15.6.0).

RRC is a higher layer signaling (protocol) used for UE and gNB configuration. This transition involves that the AMF prepares the UE context data (including, for example, PDU session context, security key, UE radio capability, and UE security capabilities, etc.) and transmits the UE context data to the gNB with an INITIAL CONTEXT SETUP REQUEST. Then, the gNB activates the AS security with the UE, which is performed by the gNB transmitting a SecurityModeCommand message to the UE and by the UE responding to the gNB with a SecurityModeComplete message. Afterwards, the gNB performs the reconfiguration to set up the Signaling Radio Bearer 2 (SRB2) and Data Radio Bearer(s) (DRB(s)) by transmitting an RRCReconfiguration message to the UE and, in response, receiving an RRCReconfigurationComplete from the UE. For a signaling-only connection, the steps relating to the RRCReconfiguration are skipped since the SRB2 and DRBs are not setup. Finally, the gNB indicates to the AMF that the setup procedure is completed with an INITIAL CONTEXT SETUP RESPONSE.

In the present disclosure, thus, an entity (e.g., AMF, SMF, etc.) of the 5th Generation Core (5GC) is provided that includes control circuitry, which, in operation, establishes a Next Generation (NG) connection with a gNodeB, and a transmitter, which in operation, transmits an initial context setup message, via the NG connection, to the gNodeB to cause a signaling radio bearer setup between the gNodeB and user equipment (UE). In particular, the gNodeB transmits a radio resource control (RRC) signaling containing a resource allocation configuration information element (IE) to the UE via the signaling radio bearer. The UE then performs an uplink transmission or a downlink reception based on the resource allocation configuration.

### <Usage Scenarios of IMT for 2020 and Beyond>

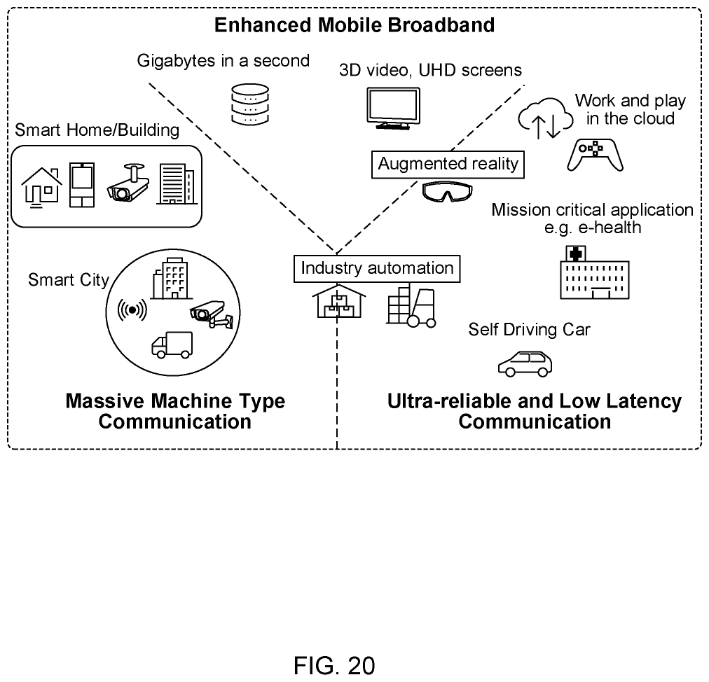

FIG. 20 illustrates some of the use cases for 5G NR. In the 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 20 illustrates some examples of envisioned usage scenarios for IMT for 2020 and beyond (see, e.g., ITU-R M. 2083 FIG. 2).

The URLLC use case has stringent requirements for capabilities such as throughput, latency, and availability. The URLLC use case has been envisioned as one of element techniques to enable future vertical applications such as wireless control of industrial manufacturing or production processes, remote medical surgery, distribution automation in a smart grid, transportation safety, etc. Ultra-reliability for the URLLC is to be supported by identifying the techniques to meet the requirements set by TR 38.913. For NR URLLC in Release 15, key requirements include a target user plane latency of 0.5 ms for uplink (UL) and 0.5 ms for downlink (DL). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for the URLLC, more compact DCI formats, repetition of PDCCH, etc. However, the scope may widen for achieving ultra-reliability as the NR becomes more stable and developed (for NR URLLC key requirements). Particular use cases of NR URLLC in Release 15 include augmented reality/virtual reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. The pre-emption means that a transmission for which resources have already been allocated is stopped, and the already allocated resources are used for another transmission that has been requested later but has lower latency/higher priority requirements. Accordingly, the already granted transmission is replaced with a later transmission. The pre-emption is applicable independent of the particular service type. For example, a transmission for a service-type A (URLLC) may be replaced with a transmission for a service type B (such as eMBB). Technology enhancements with respect to reliability improvement include dedicated CQI/MCS tables for the target BLER of TE-5.

The use case of the mMTC (massive machine type communication) is characterized by a very large number of connected devices typically transmitting a relatively low volume of non-delay sensitive data. Devices are required to be low cost and to have a very long battery life. From the NR perspective, utilizing very narrow bandwidth parts is one possible solution to have power saving from the UE perspective and enable the long battery life.

As mentioned above, it is expected that the scope of reliability improvement in NR becomes wider. One key requirement to all the cases, and especially necessary for the URLLC and mMTC for example, is high reliability or ultra-reliability. Several mechanisms can be considered to improve the reliability from the radio perspective and network perspective. In general, there are a few key important areas that can help improve the reliability. These areas include compact control channel information, data/control channel repetition, and diversity with respect to the frequency, time, and/or spatial domain. These areas are applicable to reliability improvement in general, regardless of particular communication scenarios.

For NR URLLC, further use cases with tighter requirements have been considered such as factory automation, transport industry, and electrical power distribution. The tighter requirements are higher reliability (up to 10-6 level), higher availability, packet size of up to 256 bytes, time synchronization down to the order of a few μs where the value can be one or a few μs depending on frequency range and short latency in the order of 0.5 to 1 ms (e.g., target user plane latency of 0.5 ms) depending on the use cases.

Moreover, for NR URLLC, several technology enhancements from the physical layer perspective have been identified. These technology enhancements include Physical Downlink Control Channel (PDCCH) enhancements related to compact DCI, PDCCH repetition, and increased PDCCH monitoring. In addition, Uplink Control Information (UCI) enhancements are related to enhanced Hybrid Automatic Repeat Request (HARQ) and CSI feedback enhancements. Also, PUSCH enhancements related to mini-slot level hopping and retransmission/repetition enhancements have been identified. The term “mini-slot” refers to a transmission time interval (TTI) including a smaller number of symbols than a slot (a slot includes fourteen symbols).

### <QoS Control>

The 5G Quality of Service (QoS) model is based on QoS flows and supports both QoS flows that require guaranteed flow bit rate (GBR QoS flows) and QoS flows that do not require guaranteed flow bit rate (non-GBR QoS Flows). At the NAS level, the QoS flow is thus the finest granularity of QoS differentiation in a PDU session. A QoS flow is identified within a PDU session by a QoS flow ID (QFI) carried in an encapsulation header over the NG-U interface.

For each UE, the 5GC establishes one or more PDU sessions. For each UE, the NG-RAN establishes at least one Data Radio Bearer (DRB) together with the PDU session, for example as illustrated above with reference to FIG. 19. Additional DRB(s) for QoS flow(s) of that PDU session can be subsequently configured (it is up to NG-RAN when to do so). The NG-RAN maps packets belonging to different PDU sessions to different DRBs. NAS level packet filters in the UE and 5GC associate UL and DL packets with QoS flows, whereas AS-level mapping rules in the UE and in the NG-RAN associate UL and DL QoS flows with DRBs.

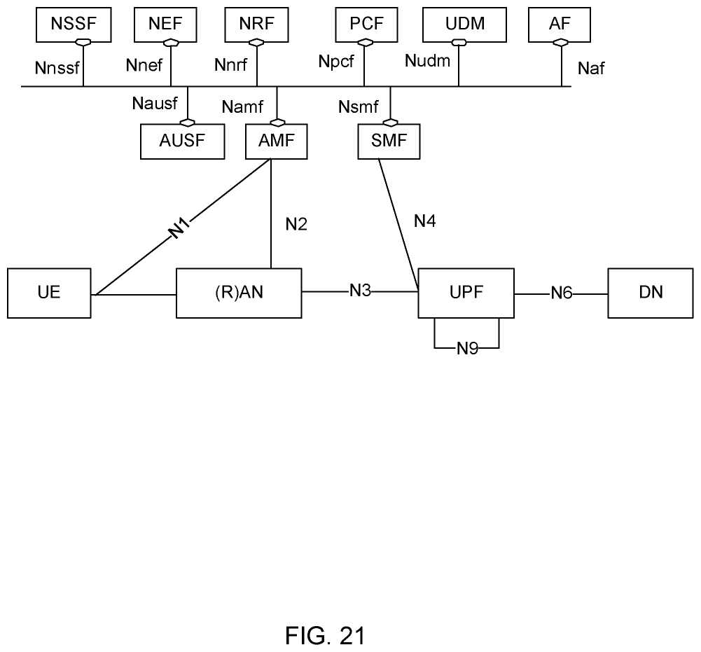

FIG. 21 illustrates a 5G NR non-roaming reference architecture (see TS 23.501 v16.1.0, section 4.23). An Application Function (AF, e.g., an external application server hosting 5G services exemplified in FIG. 20) interacts with the 3GPP core network in order to provide services, for example, to support application influence on traffic routing, accessing a Network Exposure Function (NEF) or interacting with the policy framework for policy control (see Policy Control Function, PCF), e.g., QoS control. Based on operator deployment, application functions considered to be trusted by the operator can be allowed to interact directly with relevant network functions. Application functions not allowed by the operator to access directly the network functions use the external exposure framework via the NEF to interact with relevant network functions.

FIG. 21 illustrates further functional units of the 5G architecture, namely a Network Slice Selection Function (NSSF), Network Repository Function (NRF), Unified Data Management (UDM), Authentication Server Function (AUSF), Access and Mobility Management Function (AMF), Session Management Function (SMF), and Data Network (DN, e.g., operator services, Internet access, or 3rd party services). All of or a part of the core network functions and the application services may be deployed and running on cloud computing environments.

In the present disclosure, thus, an application server (e.g., AF of the 5G architecture), is provided that includes a transmitter, which in operation, transmits a request containing a QoS requirement for at least one of the URLLC, eMMB, and mMTC services to at least one of functions (for example NEF, AMF, SMF, PCF, UPF, etc) of the 5GC to establish a PDU session including a radio bearer between a gNodeB and a UE in accordance with the QoS requirement, and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. The technique of implementing an integrated circuit is not limited to the LSI, however, and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A terminal according to an embodiment of the present disclosure includes: control circuitry, which, in operation, configures some or all of synchronization signal block numbers associated with a first transmission occasion for a first-type terminal in one time-resource, for synchronization signal block numbers associated with a second transmission occasion for a second-type terminal in one time-resource; and transmission circuitry, which, in operation, transmits a signal in the second transmission occasion.

In the embodiment of the present disclosure, the control circuitry configures a first combination of the synchronization signal block numbers associated with the first transmission occasion for a second combination of the synchronization signal block numbers associated with the second transmission occasion in a same time-resource.

In the embodiment of the present disclosure, the control circuitry determines a number of times of frequency multiplexing of the second transmission occasions in one time-resource or a number of the synchronization signal block numbers for each of the second transmission occasions so that the first combination and the second combination are identical to each other.

In the embodiment of the present disclosure, the synchronization signal block numbers corresponding to the first transmission occasion and the synchronization signal block numbers corresponding to the second transmission occasion are identical to each other in a same time resource and a same frequency resource.

In the embodiment of the present disclosure, the control circuitry configures the some of the synchronization signal block numbers associated with the first transmission occasion for the synchronization signal block numbers associated with the second transmission occasion in the first time-resource.

In the embodiment of the present disclosure, the control circuitry configures another synchronization signal block number different from the some of the synchronization signal block numbers associated with the first transmission occasion, for the second transmission occasion in a second time-resource different from the first time-resource.

In the embodiment of the present disclosure, the synchronization signal block numbers associated with the second transmission occasion in a time resource in which the first transmission occasion is configured are any of the synchronization signal block numbers associated with the first transmission occasion.

In the embodiment of the present disclosure, the terminal further includes reception circuitry, which, in operation, receives information on a configuration of an association between the second transmission occasion and the synchronization signal block numbers.

In the embodiment of the present disclosure, the control circuitry determines, based on either one of a number of times of frequency multiplexing of the second transmission occasions in one time-resource and a number of the synchronization signal block numbers for each of the second transmission occasions, and on a parameter on a configuration of the first transmission occasion, another of the number of times of frequency multiplexing and the number of the synchronization signal block numbers.

In the embodiment of the present disclosure, at least one of a plurality of the second transmission occasions is included in the first transmission occasion.

A base station according to an embodiment of the present disclosure includes: control circuitry, which, in operation, configures some or all of synchronization signal block numbers associated with a first transmission occasion for a first-type terminal in one time-resource, for synchronization signal block numbers associated with a second transmission occasion for a second-type terminal in one time-resource; and reception circuitry, which, in operation, receives a signal in the second transmission occasion.

In a communication method according to an embodiment of the present disclosure, a terminal configures some or all of synchronization signal block numbers associated with a first transmission occasion for a first-type terminal in one time-resource, for synchronization signal block numbers associated with a second transmission occasion for a second-type terminal in one time-resource, and transmits a signal in the second transmission occasion.

In a communication method according to an embodiment of the present disclosure, a base station configures some or all of synchronization signal block numbers associated with a first transmission occasion for a first-type terminal in one time-resource, for synchronization signal block numbers associated with a second transmission occasion for a second-type terminal in one time-resource, and receives a signal in the second transmission occasion.

The disclosure of Japanese Patent Application No. 2021-159523, filed on Sep. 29, 2021, including the specification, drawings and abstract, is incorporated herein by reference in its entirety.

### INDUSTRIAL APPLICABILITY

An exemplary embodiment of the present disclosure is useful for radio communication systems.

### REFERENCE SIGNS LIST

100 Base station
101, 206 Controller
102 DCI generator
103 Higher layer signal generator
104, 208 Encoder/Modulator
105, 209 Signal mapper
106, 210 Transmitter
107, 201 Antenna
108, 202 Receiver
109 Signal separator
110, 205 Demodulator/decoder
200 Terminal
203 Signal separator
204 DCI detector
207 Random access preamble generator

1. A terminal, comprising:
control circuitry, which, in operation, configures some or all of synchronization signal block numbers associated with a first transmission occasion for a first-type terminal in one time-resource, for synchronization signal block numbers associated with a second transmission occasion for a second-type terminal in one time-resource; and
transmission circuitry, which, in operation, transmits a signal in the second transmission occasion.

2. The terminal according to claim 1, wherein
the control circuitry configures a first combination of the synchronization signal block numbers associated with the first transmission occasion for a second combination of the synchronization signal block numbers associated with the second transmission occasion in a same time-resource.

3. The terminal according to claim 2, wherein
the control circuitry determines a number of times of frequency multiplexing of the second transmission occasions in one time-resource or a number of the synchronization signal block numbers for each of the second transmission occasions so that the first combination and the second combination are identical to each other.

4. The terminal according to claim 2, wherein
the synchronization signal block numbers corresponding to the first transmission occasion and the synchronization signal block numbers corresponding to the second transmission occasion are identical to each other in a same time resource and a same frequency resource.

5. The terminal according to claim 1, wherein
the control circuitry configures the some of the synchronization signal block numbers associated with the first transmission occasion for the synchronization signal block numbers associated with the second transmission occasion in a first time-resource.

6. The terminal according to claim 5, wherein
the control circuitry configures another synchronization signal block number different from the some of the synchronization signal block numbers associated with the first transmission occasion, for the second transmission occasion in a second time-resource different from the first time-resource.

7. The terminal according to claim 5, wherein
the synchronization signal block numbers associated with the second transmission occasion in a time resource in which the first transmission occasion is configured are any of the synchronization signal block numbers associated with the first transmission occasion.

8. The terminal according to claim 1, further comprising reception circuitry, which, in operation, receives information on a configuration of an association between the second transmission occasion and the synchronization signal block numbers.

9. The terminal according to claim 1, wherein
the control circuitry determines, based on either one of a number of times of frequency multiplexing of the second transmission occasions in one time-resource and a number of the synchronization signal block numbers for each of the second transmission occasions, and on a parameter on a configuration of the first transmission occasion, another of the number of times of frequency multiplexing and the number of the synchronization signal block numbers.

10. The terminal according to claim 1, wherein
at least one of a plurality of the second transmission occasions is included in the first transmission occasion.

11. Abase station, comprising:
control circuitry, which, in operation, configures some or all of synchronization signal block numbers associated with a first transmission occasion for a first-type terminal in one time-resource, for synchronization signal block numbers associated with a second transmission occasion for a second-type terminal in one time-resource; and
reception circuitry, which, in operation, receives a signal in the second transmission occasion.

12. A communication method, comprising:
configuring, by a terminal, some or all of synchronization signal block numbers associated with a first transmission occasion for a first-type terminal in one time-resource, for synchronization signal block numbers associated with a second transmission occasion for a second-type terminal in one time-resource; and
transmitting, by the terminal, a signal in the second transmission occasion.

13. A communication method, comprising:
configuring, by a base station, some or all of synchronization signal block numbers associated with a first transmission occasion for a first-type terminal in one time-resource, for synchronization signal block numbers associated with a second transmission occasion for a second-type terminal in one time-resource; and
receiving, by the base station, a signal in the second transmission occasion.
